(19) United States
(12) Patent Application Publication
(10) Pub. No.: US 2013/0163746 A1
(43) Pub. Date: Jun. 27, 2013

(54) VOICE RESPONSE UNIT (VRU) OPTIMIZATION

(71) Applicants: Matthew J. Wick, Centennial, CO (US); Michelle Hamilton, Englewood, CO (US)

(72) Inventors: Matthew J. Wick, Centennial, CO (US); Michelle Hamilton, Englewood, CO (US)

(21) Appl. No.: 13/725,664

(22) Filed: Dec. 21, 2012

Related U.S. Application Data
(60) Provisional application No. 61/578,752, filed on Dec. 21, 2011.

(51) Int. Cl. H04M 3/51

(52) U.S. Cl. CPC H04M 3/5166
USPC 379/265.14; 379/265.02; 379/265.11

(57) ABSTRACT

Systems, methods, apparatuses, and computer-readable media for voice response unit optimization are presented. Embodiments of the invention relate to providing a user with the ability to specify actions within a voice response unit (VRU). The specified actions may involve transferring a caller to a customer service representative (CSR) rather than following a pre-determined VRU call flow. In addition, users can specify how forced transfers can be routed: (1) stand alone (e.g., routing the call to the first call center), (2) shared service (e.g., routing the call to a second call center or the first call center based on the first call center's business hours or other factors), or (3) full service (e.g., routing the call to the second call center). The forced transfers can consider routing factors (e.g., call center hours of operation, wait time, skill set of CSRs).

### CROSS-REFERENCE TO RELATED APPLICATIONS

This application is a non-provisional application of U.S. patent application No. 61/578,752, filed on Dec. 21, 2011, which is herein incorporated by reference in its entirety for all purposes.

### BACKGROUND

Aspects of the disclosure relate to computing technologies. In particular, one or more aspects of the disclosure relate to voice response unit (VRU) optimization. Voice response units are known in a number of industries. However, such voice response units are not easily configurable by users. Improvements to voice response units would be desirable.

Embodiments of the invention address this and other problems, individually and collectively.

### SUMMARY

Embodiments of the invention relate to providing a user with the ability to specify actions within a voice response unit (VRU). The specified actions may involve transferring a caller to a customer service representative (CSR) rather than following a pre-determined VRU call flow. In addition, users can specify how forced transfers can be routed: (1) stand alone (e.g., routing the call to the first call center), (2) shared service (e.g., routing the call to a second call center or the first call center based on first call center's business hours or other factors), or (3) full service (e.g., routing the call to the second call center). The forced transfers can consider routing factors (e.g., call center hours of operation, wait time, skill set of CSRs).

Through the VRU disclosed in embodiments of the invention, a user has the ability to force transfer callers from an automated system and allow the user to tailor the VRU/CSR interactions to meet the user's specific needs. The voice response unit can also improve the account holder experience or promote up-sell opportunities.

One embodiment of the invention is directed to a method of generating an introduction to a menu, the menu comprising a plurality of menu options, which include a first configured menu option and a second menu option. The first configured menu option can provide a first action such as a first force transfer to a first call service center, and a second menu option can provide a second action such as a second force transfer to a second call service center. The method can further comprise initiating the first force transfer to the first call service center if the first configured menu option is selected and initiating the second force transfer to the second call service center if the second menu option is selected. The first force transfer may transfer a call to the first call service center based on one or more routing factors. The routing factors may include call center availability based on the date or time of the call or wait time. The second menu option can be subsequent to the first configured menu option in the plurality of menu options. The method may also comprise receiving one or more selected values associated with data about a caller, generating a profile for the caller that comprises the data about the caller, providing the profile to the first call service center if the first configured menu option is selected, and providing the profile to the second call service center if the second option is selected. The method may further comprise storing in a database, a string of menu options wherein at least one value in the string of menu options corresponds to the first configured menu option or the second menu option, receiving a string of selected values, comparing the string of selected values to the string of menu options, initiating the first force transfer to the first call service center if the first configured menu option corresponds to at least one of the values in the string of selected values, and initiating the second force transfer to the second call service center if the second menu option corresponds to at least one of the values in the string of selected values. The string of selected values can end with the first configured menu option or second menu option, corresponding to the last selection made by a caller.

Another embodiment of the invention is directed to a voice response unit comprising a processor and a computer readable medium coupled to the processor. The computer readable medium can comprise code for executing a method comprising generating, by a processor, an introduction to a menu that comprises a plurality of menu options. The menu options can include a first configured menu option that provides a first action such as a first force transfer to a first call service center, and a second menu option that provides a second action such as a second force transfer to a second call service center. The method can further comprise initiating, by the processor, the first force transfer to the first call service center if the first configured menu option is selected and initiating, by the processor, the second force transfer to the second call service center if the second menu option is selected. The first force transfer can transfer a call to the first call service center based on one or more routing factors. The routing factors can include call center availability based on the date or time of the call or wait time. The second menu option can be subsequent to the first configured menu option in the plurality of menu options. The voice response unit may further comprise receiving one or more selected values, wherein the one or more selected values are associated with data about a caller, generating a profile for the caller that comprises the data about the caller, providing the profile to the first call service center if the first configured menu option is selected, and providing the profile to the second call service center if the second option is selected. The voice response unit may further comprise storing in a database, a string of menu options wherein at least one value in the string of menu options corresponds to the first configured menu option or the second menu option, receiving a string of selected values, comparing the string of selected values to the string of menu options, initiating the first force transfer to the first call service center if the first configured menu option corresponds to at least one of the values in the string of selected values, and initiating the second force transfer to the second call service center if the second menu option corresponds to at least one of the values in the string of selected values. The string of selected values can end with the first configured menu option or second menu option, corresponding to the last selection made by a caller.

Another embodiment of the invention is directed to a method comprising generating a menu that may include a plurality of configurable menu options, storing, in a database, data associated with the plurality of configurable menu options, allowing a user to configure one of the menu options to create a configured menu option, and receiving the configured menu option at the database. The configured menu option may correspond with a forced transfer and the forced transfer may transfer a caller to a first call service center.

Another embodiment of the invention is directed to a voice response unit comprising a processor, and a computer readable medium coupled to the processor, the computer readable medium comprising code, for executing a method comprising generating a menu that may include a plurality of configurable menu options, storing, in a database, data associated with the plurality of configurable menu options, allowing a user to configure one of the menu options to create a configured menu option, and receiving the configured menu option at the database. The configured menu option may correspond with a forced transfer and the forced transfer may transfer a caller to a first call service center.

Another embodiment of the invention may disclose a voice response unit that maps at least one option of a plurality of menu options to a first service type. In addition, the voice response unit may map at least one other menu option of the plurality of menu options to a second service type different from the first service type. Thereafter, the voice response unit may provide a menu containing the plurality of menu options.

In one arrangement, the first service type may be a shared-service model in which calls are routed to different call centers operated by different entities based one or more routing factors, and the second service type may be a full-service model in which calls are routed to a particular call center operated by a particular service provider entity. In at least one additional arrangement, the one or more routing factors may include call center availability or wait time.

These and other embodiments of the invention are described in further detail below with reference to the Figures and the Detailed Description.

### BRIEF DESCRIPTION OF THE DRAWINGS

FIG. 1 is a block diagram that illustrates a system that utilizes a voice response unit in accordance with some embodiments.

FIG. 2 is a block diagram that illustrates the voice response unit and databases in accordance with some embodiments.

FIG. 3 shows a block diagram of a routing factors database in accordance with some embodiments.

FIG. 4 shows a block diagram of a service type database in accordance with some embodiments.

FIG. 5 shows a block diagram of a profiles database in accordance with some embodiments.

FIG. 6 shows a block diagram of a menu options database in accordance with some embodiments.

FIG. 7 is a simplified block diagram that illustrates an example of a computer apparatus in which various aspects of the disclosure may be implemented.

FIG. 8 shows a simplified flow diagram that illustrates a method of voice response unit optimization in accordance with some embodiments.

FIG. 9 shows a graphical user interface (GUI) for configuring a force transfer in accordance with some embodiments.

FIG. 10 shows a GUI that illustrates a customization menu for creating a new force transfer in accordance with some embodiments.

FIG. 11 illustrates a report displaying a summary of calls received by the voice response unit during a particular time period in accordance with some embodiments.

FIG. 12 is a simplified flow diagram that illustrates the voice response unit functionalities in accordance with some embodiments.

FIG. 13 is a flow diagram that illustrates an account menu, a plurality of menu options that the caller may choose, and a force transfer as a result of choosing particular menu options in accordance with some embodiments.

FIG. 14 is a flow diagram that illustrates a force transfer and initiating a transfer to a call service center in accordance with some embodiments.

FIG. 15 illustrates a customizable flow diagram for initiating a force transfer in accordance with some embodiments.

### DETAILED DESCRIPTION

Embodiments of the invention allow a user to customize aspects of a menu in a VRU. The menu may have a number of configurable menu options which may initiate a number of actions. Suitable actions may include force transfers to various call centers, playing of predetermined audio segments, etc. Embodiments of the invention allow one to easily customize a VRU menu without extensive programming and testing.

Aspects of the disclosure are generally directed to optimizing voice response units. Today, many organizations, from financial services companies to consumer products companies, use voice response units to provide automated assistance to customers and other callers over the phone. These voice response units not only allow organizations to extend the hours at which customers and other callers can obtain information, but also reduce the human resources that would otherwise be required to handle incoming calls and provide customer service.

In some instances, one organization may receive and handle calls for other organizations by providing voice response units that receive calls from and assist customers of these other organizations. For example, a payment processing network, such as Visa®, may deploy a voice response unit that can handle calls from and assist customers of other financial services companies, such as banks, tax accounting firms, and so on. These other financial services companies may issue payment cards and/or other payment devices, for instance, that allow their customers to conduct transactions over the payment processing network. Thus, customers of these other companies may interact with and/or receive information and customer service from both the company (e.g., the company that they are a customer of) and the payment processing network.

In instances where customer service calls are handled by a first entity (e.g., the payment processing network in the example above) and one or more voice response units operated by the first entity for a second entity (e.g., a financial services company, such as a tax accounting firm in the example above), it may be desirable and advantageous for the first entity to provide increased customizability, convenience, and control to the second entity, as this may allow the second entity to increase revenue, decrease the need for technical redundancy, and provide enhanced customer service.

For instance, the above-described tax accounting firm may want wish accountholders that select a particular telephone prompt (e.g., to add funds to a prepaid card provided by an issuer associated with the tax accounting firm) to speak with a customer service representative instead of responding to prompts in an automated system. This may provide the customer service representatives with the ability to sell additional services, which in turn may allow the tax accounting firm to generate greater revenue. Furthermore, the tax accounting firm may want the transfers to go to a call center operated by the tax accounting firm itself (e.g., internally), rather than to a call center operated by the payment processing network (e.g., externally), based on the hours of operation of the call center operated by the tax accounting firm and/or other factors. Other callers may be routed to a call center operated by the payment processing network, depending on which service model or models are in place.

In a standard VRU, customizations to the call flow can cost these tax accounting firms or the payment processing network (e.g., first and second entities, users) resources to implement, especially when the VRU is packaged and sold to multiple businesses in multiple fields with dissimilar telephonic prompts to respond to callers. Embodiments of the invention allow users to customize the VRU at key points of the call flow without excessive programming and retooling of the system by providing customized call flows at various (e.g., hundreds) points of the call flow. Thus, if the caller or user feels that the VRU provides menu options that are not sufficient for the caller or the user's needs, the user can choose to allow the caller to manage the call through a CSR at a call center instead.

For example, a user (e.g., the tax accounting firm from above) may find that 25% of its call volume over four months is dedicated to assisting callers who have reported lost or stolen cards. However, through a deeper analysis, the user discovers that a large percentage of these calls are fraudulent (e.g., the caller that reports the lost card is not actually the account holder). In other words, the menu option to report a lost or stolen card is one key point of the call flow. In a standard voice response call system, the fraudulent callers can be directed to the same customer service representative (CSR) as legitimate callers, which can cause the legitimate callers to wait longer for the CSR. This issue may be unique to the client and changing a standard system can result in significant programming time and technical resources. Instead, embodiments of the VRU provide the technical capability to customize the VRU to help mitigate the issue with fraudulent callers by sending these callers to a different CSR and allowing legitimate callers to access the CSR quicker. For example, when the user knows that the menu option to report a lost or stolen card is going to be a fraudulent caller 25% of the time, the VRU can force transfer the callers that report lost or stolen cards to a particular call center (e.g., the Denver call center), because the call center may have one or more CSRs that are trained to handle fraudulent callers (e.g., the CSR's skill set). This is one of the advantages of the VRU because the user can customize the VRU and set one or more menu options to force transfer the callers that select the lost or stolen menu option to a particular destination. Thus, when the menu option is selected by a user, the VRU can be customized to force transfer to a particular call center at a particular time with a particular skill set. Various (e.g., hundreds) menu options can also be customized according to embodiments of the invention.

In another example, a user may have released a new product (e.g., mobile application in connection with a payment account) and may want to integrate calls related to that new product into the VRU immediately. As another advantage of embodiments of the invention, the VRU can accept the customization of one or more menu options quickly. For example, the VRU can provide a prompt (e.g., “if you are calling about mobile or downloading the mobile application, press 2”) and force transfer the callers calling about the new product directly to the user's call center. The call center can provide a CSR with a skill set to handle the newly customized menu options more quickly than in a standard VRU, without substantial resources need to reprogram the VRU.

In yet another example, the caller may have previously proceeded through the call flow and provided the caller's payment account number, preferred language, and other information. However, the caller might get to the point in the call flow that does not meet his needs and want to be directed to a call center to speak with a CSR. The VRU can transfer the caller and the caller's profile (e.g. information that the VRU has gathered about the caller and stored in a database) to the call center. The call center can receive the profile information and use it to more efficiently service the caller. This can be advantageous because the CSR does not need to spend unnecessary time assisting the caller and the caller does not need to spend unnecessary time providing information that he or she provided to the VRU previously.

In still another example, the user may have determined that a particular menu option will be forced transferred and has changed his mind. For example, the user may have customized the menu option in the past to force transfer callers that call to hear their account balance to the Denver call center, but has now decided that all callers that call to hear their account balance will proceed through an automated menu. In the newly customized menu, the caller will hear his account balance through the automated menu instead of forced transferred to the call center. The VRU can be customized to change the previously determined force transfer by allowing the user to add, delete, or change rows in the databases associated with the VRU. By associating the forced transfers with databases, instead of with compiled software code or highly technical specifications, the user can quickly and efficiently change the menu options and destinations associated with the menu options.

Prior to discussing various embodiments and arrangements in greater detail, several terms will be described to provide a better understanding of this disclosure.

A “voice response unit” may be a computer system that is configured to provide interactive voice response functionalities to one or more users via one or more telephonic connections. These interactive voice response functionalities may include answering incoming telephone calls, playing back audio segments and/or otherwise providing one or more user-selectable options and/or other information to telephone callers, routing calls (e.g., to one or more customer service representatives) based on user selections and/or other factors, and/or otherwise providing automated assistance to users, such as by providing information to and/or processing commands from callers over the phone).

In many instances, a voice response unit may be configured by and/or operated by an organization, such as a financial institution, to receive and process calls from customers and/or other people. For example, the voice response unit may be configured to answer calls to a particular telephone number (e.g., a 1-800 number) and may further be configured to provide a number of options to the caller that allow the caller to complete a number of automated tasks over the phone and/or to request to speak with a customer service representative. These automated tasks may include, for instance, checking account information (e.g., account balance inquiries), making payments (e.g., by transferring funds from another account), and so on. Additionally or alternatively, the voice response unit may be configured such that a selection of a certain option (or options) results in a call being transferred to a customer service representative, who may be located at, employed by, and/or otherwise associated with a particular call center, as further described below.

A “telephonic menu” may be a set of one or more user-selectable menu options (e.g., configured menu options) that are presented by a voice response unit, for example, as a series of audio segments and/or audio prompts, where each audio prompt corresponds to one of the options included in the menu, and where each audio prompt asks the user to press a particular key (e.g., on their telephone) to select the corresponding option of the menu. For example, one such audio prompt may ask a user to “Press 4 to load funds onto your card.” In one or more arrangements, the audio prompts are provided to a caller who has placed a telephone call to the voice response unit, and the voice response unit is configured to recognize the one or more dual-tone multi-frequency (DTMF) signals produced by the caller's telephone so as to determine which option the caller selected.

A “prompt” may be a pre-recorded audio file or a series of audio files to the caller and can contain dynamic data. The caller can respond to the prompt by selecting a response via the telephone (e.g., pressing “4”) or providing some other interaction with the voice response unit.

A “service model” may define the way in which a voice response unit routes calls to customer service representatives and/or call centers. In particular, in one or more embodiments, different options within a telephonic menu may be mapped to different service models. When a user selects a particular option, a voice response unit may determine how the call should be routed based on the service model that corresponds to the selected option. For example, one service model may specify that calls should be routed to one of two call centers depending on the day of the week, the time of day, call center availability levels (e.g., how many customer service representatives are present and/or available at each call center) estimated wait time at each call center (e.g., how long a caller might need to wait to speak to a customer service representative at each call center), and/or other factors. On the other hand, another service model may dictate that all calls should be routed to a particular call center at all times (e.g., irrespective of any factors, such as those described above).

A “call center” or “call service center” may be a physical establishment that houses many customer service representatives, and are used interchangeably herein. Additionally or alternatively, the term “call center” may refer to a plurality of call centers owned and/or operated by a single entity. For example, a “call center” may actually include a plurality of different physical establishments in which customer service representatives are housed, and/or may encompass a plurality of different customer service representatives working from different locations, such as their individual homes.

A “shared-service model” may be a service model where one or more routing factors are evaluated and used in determining which call center a call should be routed to. Additionally or alternatively, in a shared-service model, one call center to which calls may be routed may be a first call center owned and/or operated by a first entity (e.g., a payment processing network, such as Visa®), and another call center to which calls may be routed may be a second entity (e.g., a client or business partner of the payment processing network, such as a bank or financial services company). For example, the first entity may provide after hours and holiday support and the second entity can provide support during its call center's normal business hours (e.g., 9 AM to 5 PM).

A “full-service model” may be a service model where one or more calls are routed to a first call center of a plurality of call centers associated with (e.g., owned and/or operated by) a first entity. For example, the first entity may be a payment processing network, such as Visa®, and options mapped to the full-service model may be handled entirely by customer service representatives employed by and/or otherwise associated with the first entity (e.g., the payment processing network).

A “stand alone model” may be a service model where one or more calls are routed to a first call center a plurality of call centers associated with (e.g., owned and/or operated by) a second entity associated with the first entity (e.g., a client of the first entity).

A “routing factor” may be data that the VRU uses in determining which call center a particular call should be routed to. Examples of routing factors include the day of the week, time of day, call center availability, estimated wait times, or other factors.

A “forced transfer” may be an instruction submitted by or to the voice response unit to transfer a call to a particular destination (e.g., a call service center). Forced transfers may be configured by the user at the function type level in association with particular menu options. For example, a user could have configured a forced transfer to be initiated for menu option 2 (e.g., “to listen to the card balance, press 2”). When a caller selects menu option 2, the caller may be transferred to the Denver call center to authenticate the caller and provide the caller with a card balance.

A “transfer number” may be a number that corresponds to a selected option that instructs the voice response unit to transfer a call. For example, a user could have configured a forced transfer to be initiated for menu option 2 (e.g., “to listen to the card balance, press 2”). When a caller selects menu option 2, the instruction provided to the voice response unit is “23° C. 82,” where “82” is the transfer number that instructs the voice response unit to transfer the call to a customer service representative without authentication. The caller may be transferred to the Denver call center and the Denver call center can be notified by the voice response unit to authenticate the caller and provide the caller with an account balance.

As used herein, a “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to one or more databases and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

As used herein, an “issuer” may include a business entity (e.g., a bank) that maintains financial accounts for consumers such as individuals, businesses, and other entities, and that may issue portable consumer devices such as credit and debit cards to consumers and/or callers. The issuer may operate an issuer computer, that performs the functions of the issuer.

I. Exemplary Systems

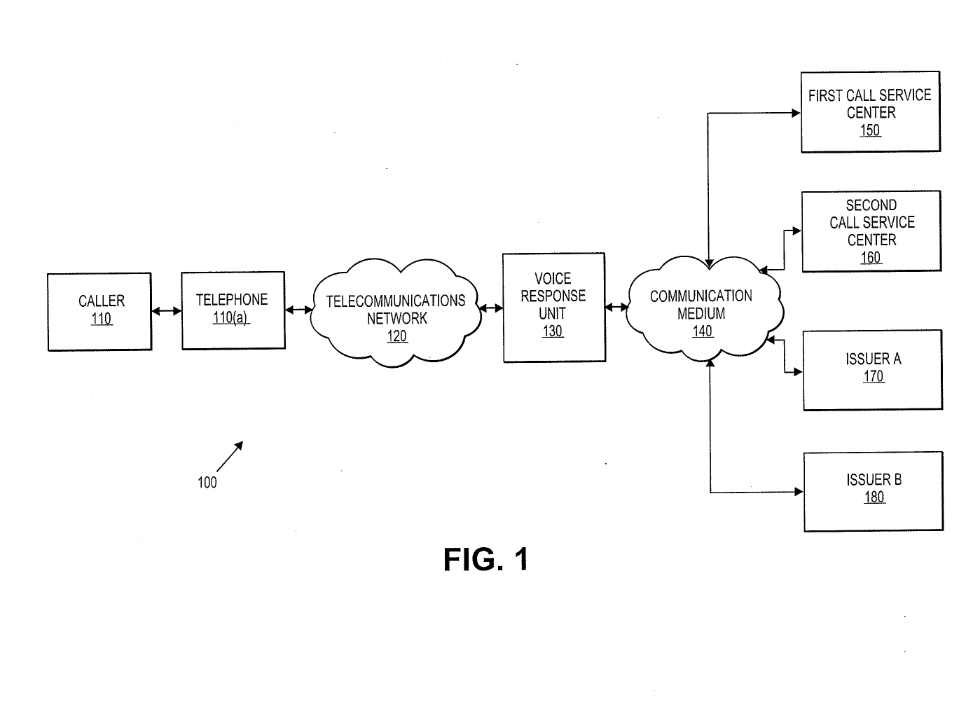

FIG. 1 is a block diagram that illustrates a system that utilizes a voice response unit in accordance with some embodiments.

The system 100 in FIG. 1 depicts a caller 110 and a telephone 110(a) associated with a caller 110, a telecommunications network 120, and a voice response unit 130 all in operatively coupled together. The voice response unit 130 may also be operatively coupled to a communications medium 140, which in turn may be associated with a first call service center 150, second call service center 160, issuer A 170, and issuer B 180. Each of the first call service center 150, second call service center 160, and the issuers A, B 170, 180 may operate server computers (not shown). According to an illustrative embodiment, the caller 110 can initiate a telephone call using the telephone 110(a) over a telecommunications network 120 to a voice response unit 130.

In some embodiments, the caller 110 can be a consumer that calls a telephone number using a telephone 110(a) after the consumer purchases products or services via an electronic transaction. Non-limiting examples include a person or business entity that calls the telephone number associated with the person or business that the caller purchased goods and services from using a credit card, debit card, e-check, etc.

The telephone 110(a) may be any device that allows the caller 110 to communicate over a telecommunications network 120 with a voice response unit 130. Non-limiting examples of telephones include mobile devices, smart phones, short range wireless radio devices for communications, and computers with call-enabling computer software (e.g., Skype®).

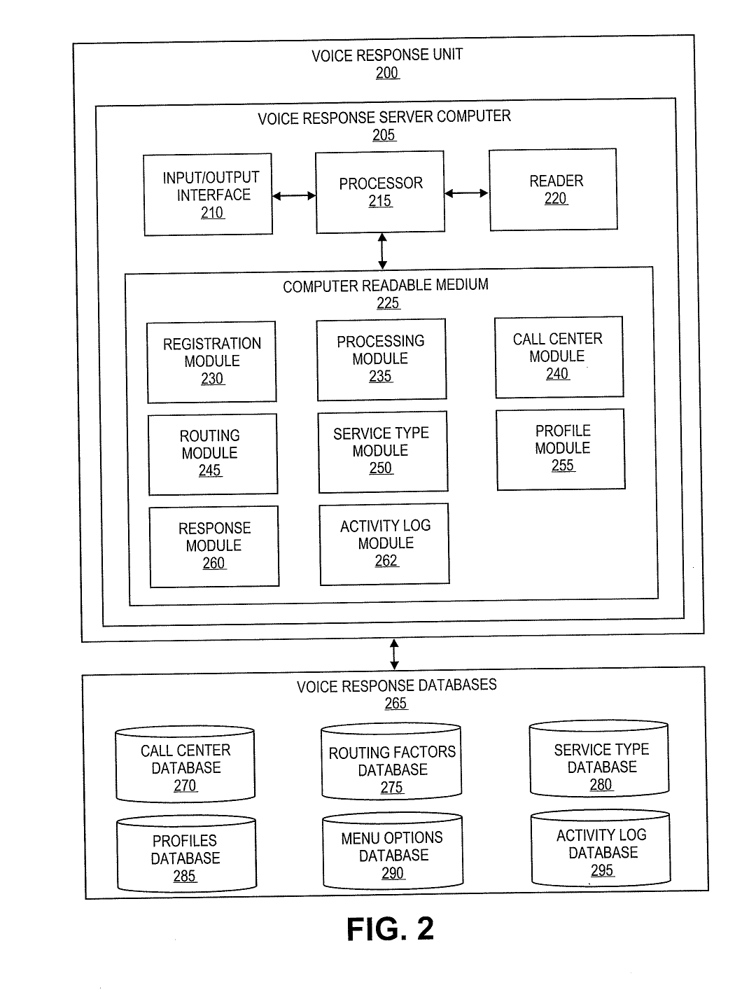

The voice response unit 130 (VRU) can include one or more server computers and/or databases that can accept a call from the caller 110, process the call, and transfer the call to other entities over a communication medium 140. When the call is processed by the VRU, the VRU can provide prompts to a caller and receive responses and selected menu options from the caller in response to the prompts. Additional information about the VRU is illustrated in FIG. 2.

The voice response unit 130 may contact a first call service center 150, a second call service center 160, issuer A 170, or issuer B 180 via a communication medium 140. The communication medium may comprise any suitable wired or wireless network. The VRU 130 can be equipped to force transfer the call to the first call service center 150 or the second call service center 160 or transmit at least a portion of the information received from the caller 110 over the communication medium 140 to another entity.

Additional information may be transmitted along with the information described. For example, the caller 110 may provide a primary account number associated with a payment account to the voice response unit 130. The voice response unit 130 may transmit the primary account number to the first call service center 150 in addition to initiating a transfer of the caller to the first call service center 150. The VRU may also communicate with issuer A 170 and issuer B 180. Any or all of the information referenced above, which is transmitted or received from the caller by the voice response unit may be transmitted through a network of any suitable protocol. An example of a suitable protocol is Secure Sockets Layer (SSL).

Issuer A 170 and issuer B 180 may each be a business entity (e.g., a bank) that maintains financial accounts for consumers such as individuals, businesses, and other entities, and that may issue portable consumer devices such as credit and debit cards to consumers. For example, the issuer(s) that operates issuer A 170 and issuer B 180 may issue one or more portable consumer devices to the caller 110. Issuer A and issuer B may also provide authentication and authorization services for the VRU. In an embodiment, the issuer may be a payment processing network capable of establishing a financial account (e.g., prepaid card account).

An example of a voice response unit will now be provided in FIG. 2. FIG. 2 is a block diagram that illustrates the voice response unit and databases in accordance with some embodiments. It should be appreciated that the voice response unit and databases are provided for illustrative purposes and not intended to limit ways in which a voice response unit may be executed in the system 100. For example, the voice response unit may contain databases within the voice response unit 200 instead of external voice response databases 265 as shown in FIG. 2.

In an embodiment of the invention, the voice response unit 200 can comprise a processor 215 and a computer readable medium 225 coupled to the processor 215. The computer readable medium 225 can comprise code for executing a method comprising generating, by the processor, an introduction to a menu, the menu comprising a plurality of menu options, the menu options including a first configured menu option in the plurality of menu options, wherein the first configured menu option provides a first force transfer to a first call service center, and a second menu option in the plurality of menu options, wherein the second menu option provides a second force transfer to a second call service center. The method may also comprise initiating, by the processor, the first force transfer to the first call service center if the first configured menu option is selected and initiating, by the processor, the second force transfer to the second call service center if the second menu option is selected.

In an embodiment of the invention, the voice response unit 200 can comprise a processor 215 and a computer readable medium 225 coupled to the processor 215. The computer readable medium 225 can comprise code for executing a method comprising generating a menu that may include a plurality of configurable menu options, storing, in a database, data associated with the plurality of configurable menu options, allowing a user to configure one of the menu options to create a configured menu option, and receiving the configured menu option at the database. The configured menu option may correspond with a forced transfer and the forced transfer may transfer a caller to a first call service center.

The voice response unit 200 may comprise a voice response server computer 205 and be in communication with voice response databases 265. The voice response server computer 205 can include an input/output interface 210, processor 215, reader 220 (e.g., a contactless reader, disk reader), and a computer readable medium 225. The computer readable medium 225 may contain a plurality of modules.

The input/output interface 210 can be a display, speakers, network interface, mouse, keyboard, or other devices used to communicate between callers, businesses, and server computers. In accordance with an embodiment, these communications can be established through telecommunications network or communications medium.

The voice response server computer 205 can include a processor 215 to perform functions stored in the computer readable medium 225 of the voice response server computer 205. The processor 215 may be coupled to a computer readable medium 225. The computer readable medium 225 can include memory, an operating system, and several modules and code specific to the functions of the voice response server computer 205 for executing a method. For example, computer readable medium 225 can execute a method comprising generating, by the processor, an introduction to a menu, the menu comprising a plurality of menu options, the menu options including a first configured menu option in the plurality of menu options, wherein the first configured menu option provides a first force transfer to a first call service center, and a second menu option in the plurality of menu options, wherein the second menu option provides a second force transfer to a second call service center; initiating, by the processor, the first force transfer to the first call service center if the first configured menu option is selected; and initiating, by the processor, the second force transfer to the second call service center if the second menu option is selected.

As shown in FIG. 2, the computer readable medium 225 can include a registration module 230, processing module 235, call center module 240, routing module 245, service type module 250, profile module 255, response module 260, and activity log module 262. It should be appreciated that the modules presented are provided for illustrative purposes and not intended to limit ways in which a voice response unit may be implemented.

The registration module 230 may process registration information from a user who utilizes the voice response unit to interact with callers. The registration module may establish the user as a registered user. The registration module 230 can additionally determine the customization menu options available to a particular user by extracting registration request information from the user and storing the customized menu options in the menu options database 290. While determining the customizing of menu options, the registration module 230 may store a string of menu options in the menu options database 290. A string of menu options may include many values in the string, including at least one value that corresponds to a first configured menu option or a second menu option.

The processing module 235 may process information, including registration information from a user and incoming calls from callers for the voice response unit 200. The processing module 235 can receive messages and parse the information in the message to populate data in appropriate databases. For example, when the processing module 235 receives a request to establish a list of customized menu options from a business, the processing module 235 may parse the message, extract the menu options that require a forced transfer to a call service center, and store information from the message to the menu options database 290. In another example, the processing module may receive a request to force transfer a caller. The processing module may parse the request, and query the call center database 270, routing factors database 275, or service type database 280 to determine the appropriate location for the force transfer.

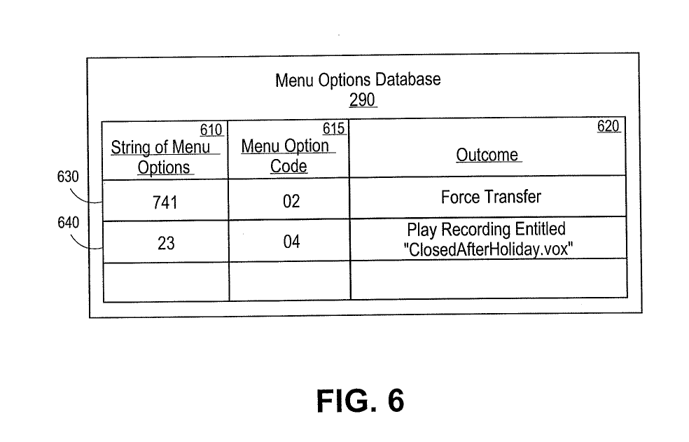

The processing module 235 may also generate a menu that includes a plurality of configurable menu options. As shown above, the processing module 235 may parse a message, extract the menu options that require a forced transfer to a call service center, and store information from the message to the menu options database 290. The processing module may also allow the user to configure the menu options. If the user chooses to configure a menu option (e.g., by submitting a message), the processing module 235 may receive a message with instructions to change the menu options, parse the message, extract the changes to the menu options, and store the updated information from the message to the menu options database. The message may contain a configured menu option and the configured menu option may be added to the database. Similarly, if the user decides to delete a pre-existing menu option, the menu option may be considered a configured menu option. The processing module may receive the message with the configured menu option, parse the message, extract the changes to the menu options (e.g., the configured menu option), and delete the pre-existing information in the menu options database. The configured menu option may correspond with a forced transfer to a call service center in the menu options database 290, as shown in FIG. 6.

The computer readable medium 225 may also include a call center module 240. The call center module 240 can manage information and processing for interacting with the call center(s). For example, the call center module 240 can query the call center database 270 to retrieve information about a call center. Information may include the address of the call center, number of available call center representatives at a particular skill level, or the call center's hours of operation.

The routing module 245 can initiate a transfer or route a particular call to a particular call center, which may include querying the call center database 270 and/or the routing factors database 275. The routing module 245 can be invoked when the voice response unit 200 initiates a force transfer to a call center. The routing module 245 can query the call center database 270 to determine if a particular call center is available or can help a caller based on the level of expertise available at the call center. A string of menu options may have been stored in the menu options database 290, wherein at least one value in the string of menu options corresponds to a first menu option or a second menu option. The routing module 245 can receive a string of selected values from the profile database 285. The routing module 245 can also query the routing factors database 275 to determine which call centers are available for the transfer. Particular call centers may be available based on the date or time of the call, the duration of the call in comparison to when the force transfer is initiated, or the wait time of the caller.

The routing module 245 may also settle discrepancies if more than one routing factor is applicable for a certain call. For example, the voice response unit may receive a call on a holiday during normal work hours of the Denver call service center. The routing module may query the routing factors database 275 to determine that the Denver call service center is normally open on Mondays at 9 AM, but the routing module can also determine that the date of the call is a holiday and the Denver call service center is closed on holidays. The routing module 245 can initiate a transfer to an alternative call center because the routing module would determine that the holiday routing factor supersedes the normal work hour routing factor.

The routing module 245 may also compare a string of selected values with a string of menu options. In an embodiment, the string of selected values and string of menu options may be one or more numerical values instead of strings of characters. If a portion of the string of selected values corresponds with a portion of a string of menu options, the routing module 245 may initiate a transfer to an applicable call center. For example, the caller may submit a string of selected values by selecting the digit 7 in response to a menu option, then 4 in response to the next menu option, then 1, then 7, and then 3. The last selection made by the caller may be “73.” These selected values may create a string of selected values of “74173,” and can be stored in the profiles database 285. The menu options database 290 may contain a stored string of menu options “73,” which corresponds with the first menu option. The routing module 245 can compare the string of selected values to the string of menu options and determine that the string “73” is present in the string of selected values in the profiles database with the string of menu options in the menu options database. If the first menu option (“73”) corresponds with at least one of the values in the string of selected values (“74173”), then the routing module 245 can initiate a first force transfer to the first call service center. In this example, since the string of menu options “73” corresponds with the first menu option, the routing module 245 initiates the transfer to the first call service center.

The routing module 245 may also determine that the string of selected values ends with the first menu option, because “73” is the last two digits or characters in the string of selected values “74173.” In an embodiment, the end of the string of selected values corresponds to the last selection made by the caller. In another embodiment, the string of selected values provides an exit reason which corresponds to the reason why the caller exited the system (e.g., “73”, or “request to close account”).

The service type module 250 can determine how to handle a caller's selected value or menu option code (e.g., to route the call to a call service center) based on the type of service that has been associated with the selected value and/or menu option code. The service type module 250 can retrieve the service type information form the service type database 280. For example, the potential service types may include full service, shared service, and stand alone.

The profile module 255 can receive one or more menu option codes associated with data about a caller and generate a profile of data about the caller in the profiles database 285. This information can be provided to a call center representative after a forced transfer to assist the call center representative in assisting the caller. For example, the caller may have exited from the VRU and the profile information can contain the reason why the caller exited from the VRU (e.g., requested to add funds to an account, which initiated a forced transfer). In another example, if the caller previously provided the caller's primary account number associated with a payment account, the profile module 255 may query the profiles database 285 to retrieve the primary account number and the caller's name. The profile module may also be used to help transmit the information to the call center representative, in order to make the process more efficient and less frustrating for the caller who may need to provide the same information multiple times. When more than one call service center is available, the profile module 255 may provide the profile to the first call service center if the first menu option is selected and provide the profile to the second call service center if the second option is selected. This may be advantageous because the call service center can receive a profile for the caller when the caller is directed to a particular call service center, which helps manage the amount of information for the call service center to relevant callers and reduces the sensitive information transmitted between locations (e.g., the VRU to the call service center).

The response module 260 can be used to play recordings to the caller after a particular menu option is selected. In an embodiment, the voice response unit 200 may play the recording without a selected value from the caller (e.g., a welcome message). The response module 260 may query the menu options database 290 to retrieve the recordings file or retrieve the location of the recordings file that is saved in another location. The recordings files can be saved in any appropriate format, including waveform audio file format (.WAV), audio compression file formats (.MP3), dialogic voice audio file (.VOX), and the like.

The activity log module 262 can be used to process and store information about the caller's progression through the call flow in the activity log database 295. For example, the activity log module can process information about the language or function type that the caller selected and how long it took the caller to progress through the menu options.

The voice response unit 200 may be communicatively coupled to voice response databases 265. The voice response databases 265 may include a call center database 270, routing factors database 275, service type database 280, profiles database 285, menu options database 290, and activity log database 295. It should be appreciated that the databases provided are for illustrative purposes and not intended to limit ways in which a voice response unit may be implemented. For example, the voice response databases 265 may be located within the voice response unit 200 in other embodiments.

The call center database 270 can be utilized by the call center module 240 to track the status of each call center. For example, the call center database 270 can include the call center's hours of operation, holiday hours, number of skilled call center associates available, estimated wait times, etc. This information can be utilized to help the voice response unit 200 determine whether to initiate a forced transfer to a particular call center.

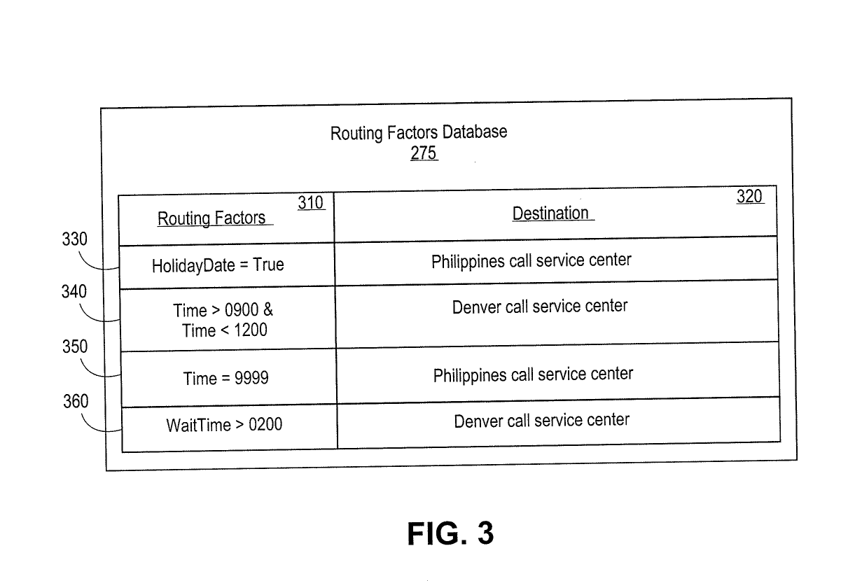

The routing factors database 275 can be utilized by the routing module 245 as described above to identify which call center a particular caller should be routed to. An illustration of the contents of an exemplary routing factors database is further described in relation to FIG. 3.

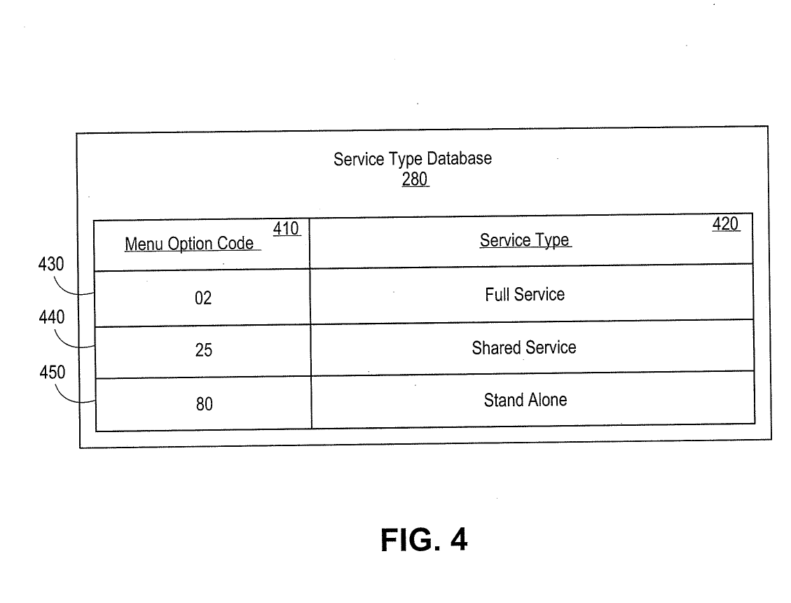

The service type database 280 can store information about the service types associated with menu option codes. The service type module 250 may utilize the service type database 280 as described above, and is explained in further detail in relation to FIG. 4.

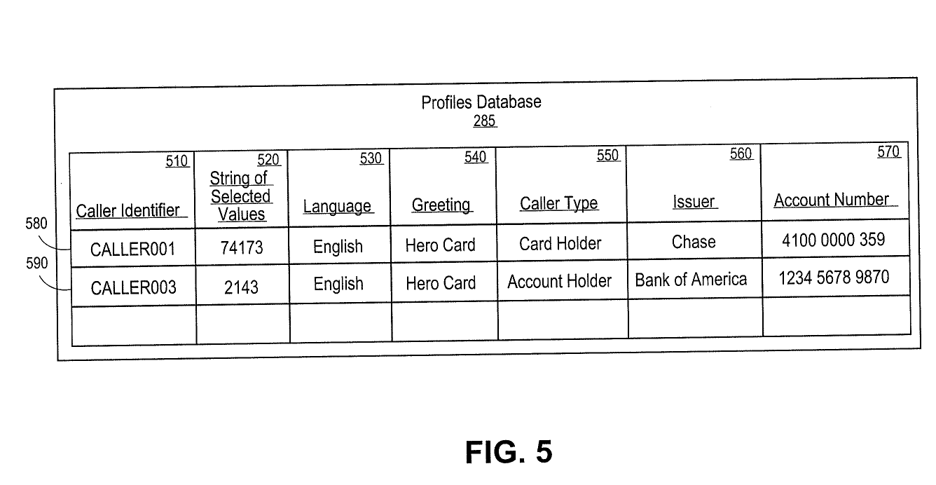

The profiles database 285 can be utilized to store information about a caller. The profile module 255 may utilize the profiles database 285 as described above to store information about the caller and potentially retrieve the profile information if the caller selects a forced transfer menu option. An illustration of the contents of the profiles database can be found in relation to FIG. 5.

The menu options database 290 can store information about the menu options provided by the voice response unit 200. Default or customized menu options can be saved in the menu options database (e.g., “to hear the current time in Spain, press 3”). The menu options database can contain information directing certain menu options to force transfer and other menu options to play a particular response to the caller. An illustration of the contents of the menu options database can be found in relation to FIG. 6.

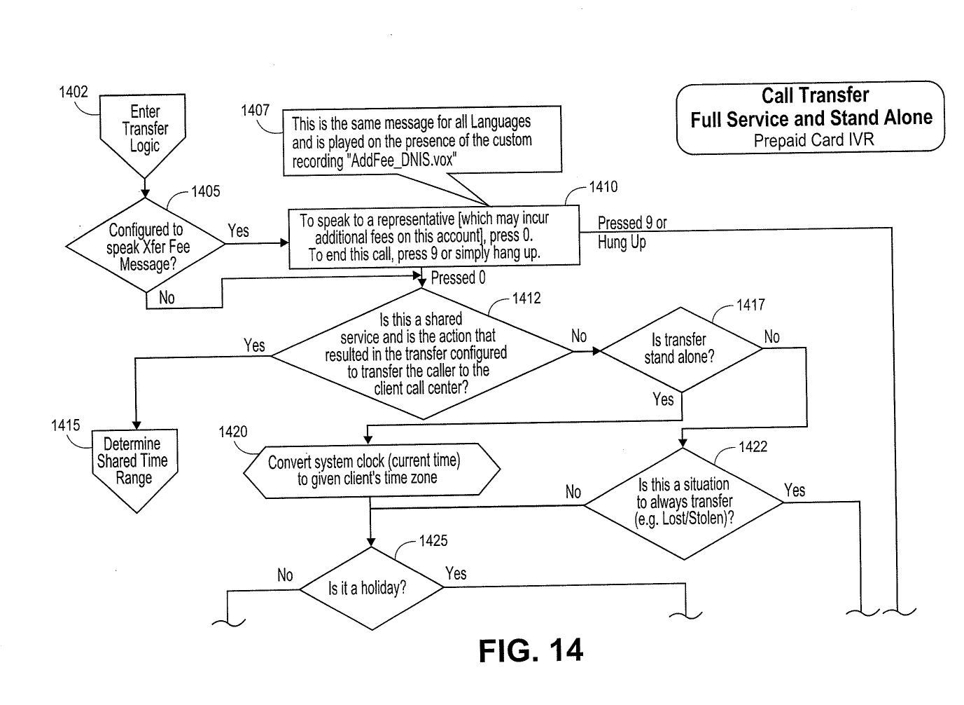

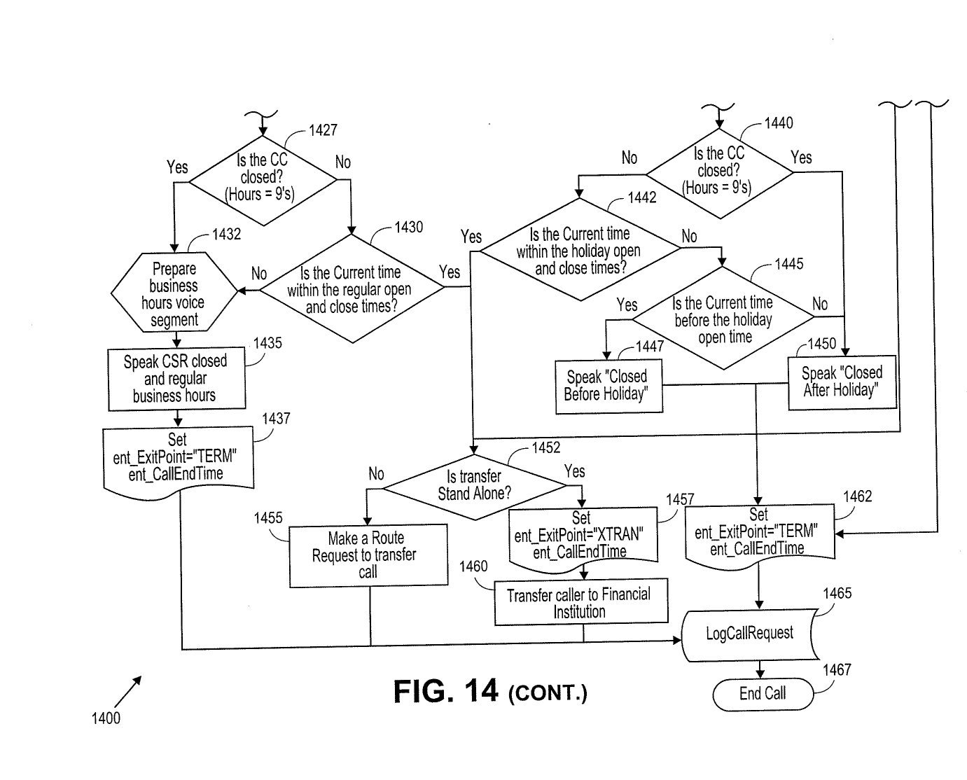

The activity log database 295 can store information about the interactions, prompts, functions, and other activity conducted by the voice response unit 200. The VRU can store the caller activity data to document which menu options a caller experienced. For example, the activity log module 262 may store this information in the activity log database 295 when the call flow diagram (e.g., FIG. 14 at 1465) states “LogCallRequest.” The information in the activity log database can be used by reports. The activity log module may help the user understand if the caller successfully finished a module, or had another outcome while in the module.

FIG. 3 shows a block diagram of a routing factors database in accordance with some embodiments. The routing factors database 275 can include multiple columns of data, including routing factors 310 and destination 320. For example, destination 320 can define the call center destination of a forced transfer. In an embodiment, when the routing factor is true, the voice response unit initiates a force transfer to the associated call service center. For example, as shown in row 330, when the date of the call is a holiday and the menu option selected by the caller causes the voice response unit to initiate a force transfer, the routing factor at row 330 can be true. The voice response unit can then initiate a force transfer to the Philippines call service center. In another example, as shown in row 340, when the time of the call is between 0900 and 1200, the routing factor at row 340 is true. The voice response unit can then initiate a force transfer to the Denver call service center. In yet another example, as shown in row 350, when the time of the call is 9999, the routing factor at row 350 is true and the voice response unit can initiate a force transfer to the Philippines call service center. In another example, at row 360, when the wait time experienced by the caller is greater than 0200, the routing factor at row 360 is true. The voice response unit can initiate a force transfer to the Denver call service center.

FIG. 4 shows a block diagram of a service type database in accordance with some embodiments. In an embodiment, the service type database 280 can correlate menu option code 410 with an associated service type 420. In an embodiment, the menu option code may be the value selected by the caller that corresponds to the menu option the caller selected (e.g., menu option code “14” corresponds with the caller's selection to hear the balance on her account). For example, as shown in row 430, when the menu option code is “02,” the service type associated with the menu option code is full service. The user may have chosen the menu option code of “02” (e.g., relating to discontinuing the service) with a full service option (e.g., directing the call to the Denver call service center). In another example, as shown in row 440, when the menu option code is “25,” the service type for the menu option code is shared service. In yet another example, as shown in row 450, when the menu option code is “80,” the service type for the menu option code is stand alone.

The service type database 280 can also be used to determine which menu option codes correspond with forced transfers. For example, menu option codes “02,” “25,” and “80” correspond with forced transfers by defining how to handle each forced transfer (e.g., “full service,” “shared service,” and “stand alone,” respectively). In an embodiment, when a menu option code is not listed in the service type database 280, that menu option code is not associated with a forced transfer. This may be used as a quick and effective way to customize the VRU for a user. As shown in an example above, the user may have determined that a particular menu option will be forced transferred and has changed his mind. The user can simply delete the menu option code from the service type database 280 to stop the corresponding menu option from initiating a forced transfer.

As a way of illustration, the user may have customized the menu option in the past to force transfer callers that call to hear their account balances to the Denver call center, pursuant to a stand alone service type, but has now decided that all callers that call to hear their account balance will proceed through an automated menu. This menu option code may be “80,” as shown in row 450. Once the user has decided that these callers will proceed through the automated menu instead of being directed to the CSR, the user can delete row 450. By deleting row 450, the menu options code “80” may no longer correspond with a stand alone service type and may not be forced transferred (e.g., as defined in the menu options database 290). After row 450 is deleted, the newly customized menu will be provided to the caller and the caller will hear his account balance through the automated menu instead of forced transferred to the call center. If row 450 was not deleted, the VRU may determine that a forced transfer is necessary, then query the destination for the forced transfer based on the call service center's holiday schedule, hours of operation, etc.

FIG. 5 shows a block diagram of a profiles database in accordance with some embodiments. The profiles database 285 can receive one or more selected values associated with data about a caller from the profile module 255, and store the information in the database, including a caller identifier 510, string of selected values 520, language 530, greeting 540, caller type 550, issuer 560, and account number 570. The profiles database 285 may provide the data to the profile module 255 when the profile module 255 generates a profile for the caller. It should be appreciated that the information contained in the profiles database 285 and any other database illustrated herein are provided for illustrative purposes and not intended to limit ways in which a voice response unit may be implemented in the system 100.

As an example, at row 580, the voice response unit may store information related to a first caller, referred to as “CALLER001” in the profiles database 285. Some of the information may include a string of selected values received from the caller (“74173”) and the preferred language of the caller (English). In an embodiment, the string of selected values provides an exit reason which corresponds to the reason why the caller exited the system (e.g., “25”, or “request to close account”). The voice response unit may have transmitted a particular greeting to the user (Hero Card) based on the string of selected values, account number, or other identifying information. The caller may have identified the type of caller they are (card holder), issuer (Chase), and account number (4100 0000 359) associated with the call. Alternatively, the information may be stored and queried from a database, received and stored from previous call, or unnecessary and left blank. As another example, at row 590, CALLER003 may also have information associated with him or her. For example, the information includes a string of selected values (“2143”), language (English), greeting (Hero Card), caller type (account holder), issuer (Bank of America), and account number (1234 5678 9870).

FIG. 6 shows a block diagram of a menu options database in accordance with some embodiments. The menu options database 290 can store information about the menu options presented by the voice response unit. The menu options database 290 can include a string of menu options 610, menu option code 615, and the outcome 620 associated with the string of menu options, wherein the menu option code 615 in the menu options database 290 corresponds with menu option code 410 in the service type database 280. For example, as shown in row 630, when “741” is received as a string of menu options at a particular time, the voice response unit can query the menu options database and determine that this string of menu options will initiate a forced transfer, as shown by outcome 620. When the string of menu options corresponds with a forced transfer, the routing module 245 can determine how to handle the forced transfer by querying the service type database 280. In an embodiment, the menu option code 615 in the menu options database 290 can have a corresponding menu option code 410 in the service type database 280 to define how to handle the force transfer. For example, menu option code “02” in the menu options database 290 corresponds with the menu option code “02” in the service type database 280. The service type database 280 correlates menu option code “02” with a “full service” service type. The routing module 245 may determine that when string of menu options 610 is “741,” the VRU will handle the call as a “full service” service type (menu option code) and force transfer the call (outcome). In an embodiment, the menu options database 290 and service type database 280 may be one database.

In another example, string of menu options may not force transfer the call, as shown in row 640. When “23” is received as a string of menu options, the voice response unit can query the menu options database 290 and determine that when “23” is received as a string of menu options at a particular time, the voice response unit can play a recording entitled “ClosedAfterHoliday.vox.” Further, the menu code option 615 that corresponds to row 640 (“04”) may not appear in the service type database 280 because there is no forced transfer associated with the menu option code or string of menu options.

The menu options database 290 may store data associated with a plurality of configurable menu options. The menu options database 290 can allow a user to configure one or more menu options to create a configured menu option. Each row in the menu options database 290 may correspond with a configured menu option. By using modules (e.g., processing module 235, service type module 250) or accessing the menu options database directly, the menu options database 290 can receive the configured menu option from the user or the VRU.

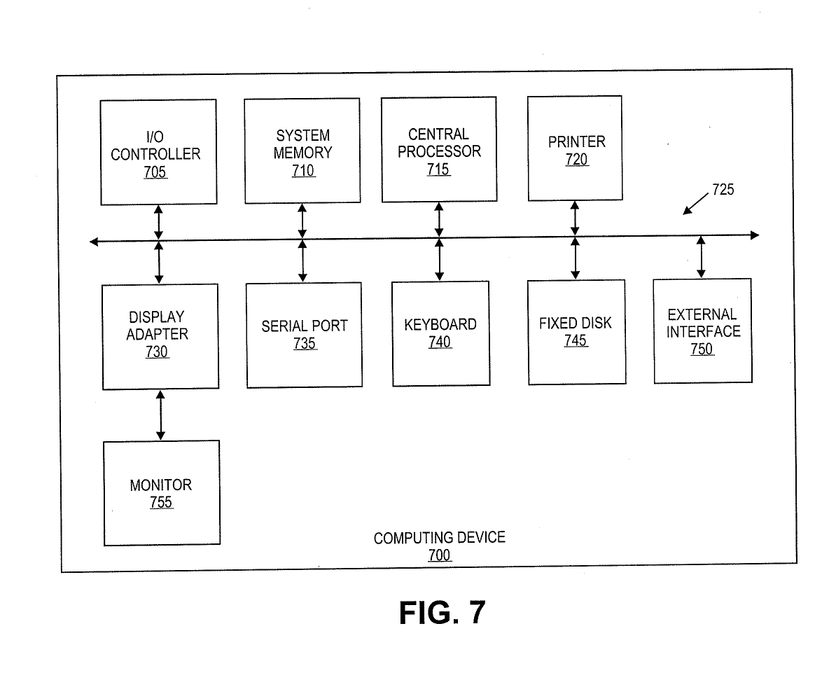

FIG. 7 is a simplified block diagram that illustrates an example of a computing device in which various aspects of the disclosure may be implemented. Any of the entities, for example, in FIG. 1 may utilize the computing device in FIG. 7 or any of its components. For example, the voice response unit described above may implement and/or otherwise use one or more of the subsystems and/or components of the computing device 700 illustrated in FIG. 7.

As seen in FIG. 7, computing device 700 may include a plurality of subsystems, which may be interconnected by a system bus 725. Additional subsystems, such as a printer 720, keyboard 740, fixed disk 745 (or other memory and/or computer-readable media), monitor 755, which is coupled to display adapter 730, may also be connected to the system bus 725. Peripherals and input/output (I/O) devices may be coupled to I/O controller 705 and can be connected to the computing device 700 by any number of means known in the art, such as serial port 735. For example, serial port 735 or external interface 750 can be used to connect the computing device 700 to a wide area network, such as the Internet, a mouse input device, or a scanner, for example. The interconnection via the system bus 725 allows the central processor 715 to communicate with each subsystem and to control the execution of instructions from system memory 710 and/or the fixed disk 705, and further allows the central processor 715 to control the exchange of information between subsystems. Additionally or alternatively, the system memory 710 and/or the fixed disk 745 may embody a computer-readable medium.

II. Exemplary Methods

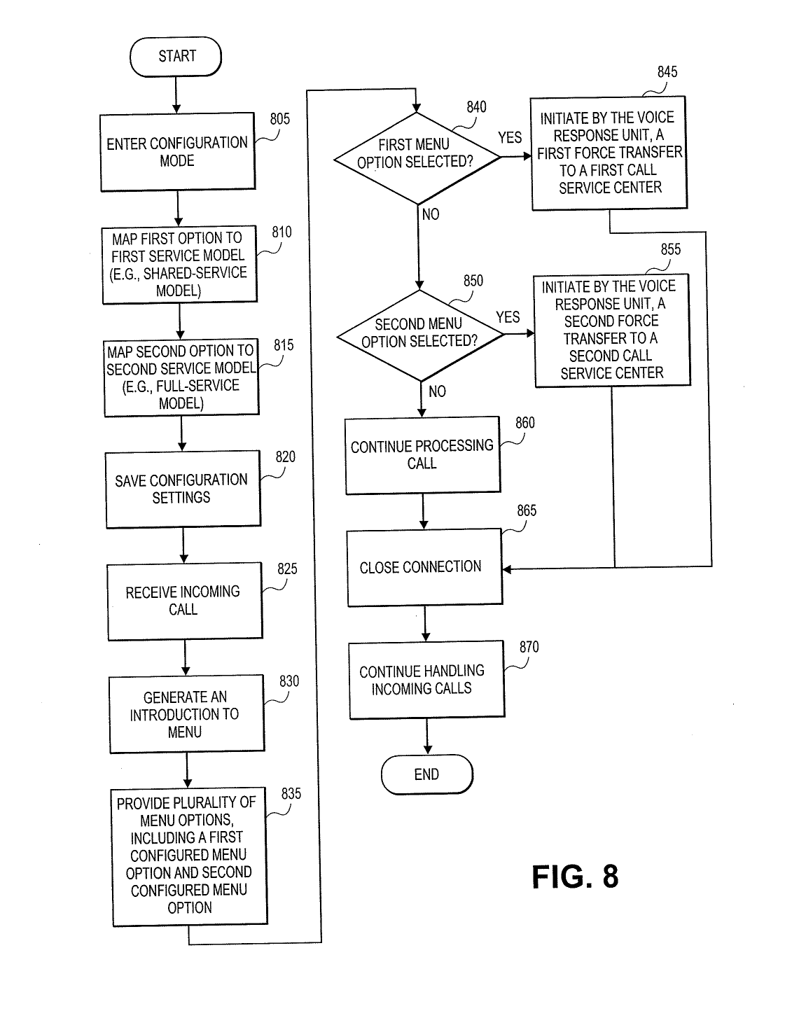

FIG. 8 shows a simplified flow diagram that illustrates a method of voice response unit optimization in accordance with some embodiments. In one or more embodiments, any and/or all of the methods and/or method steps illustrated in FIG. 8 may be performed by a computing device, such as a voice response unit. Additionally or alternatively, any and/or all of the methods and/or method steps illustrated in FIG. 8 may be embodied in computer-readable instructions stored in a memory or other computer-readable medium that, when executed, cause at least one computing device to perform such methods and/or method steps (e.g., as illustrated in FIG. 2).

In step 805, a computing device (e.g., a voice response unit) may enter a configuration mode in which one or more menus (e.g., one or more telephonic menus) may be defined. For example, in step 805, a voice response unit may be placed in and/or otherwise enter a configuration mode in which one or more settings may be defined, specified, and/or stored, such as settings defining one or more telephonic menus with one or more menu options. In at least one arrangement, the voice response unit may receive these settings as user input from a programmer or technician who is employed by and/or otherwise associated with an entity that is deploying the voice response unit. The configuration may also be provided by configuration file (e.g., client configuration file (CCF)).

While in configuration mode, the user can customize the VRU by, for example, providing forced transfer information. In this example, calls may be routed to a first call service center based on language selected, hours of operation including holiday schedules, or the number of customer service representatives with a particular skill set (e.g. a skill set to help callers with questions about mobile functionality).

In step 810, a first menu option in a telephonic menu may be mapped to a first service model. For example, in step 810, the voice response unit may receive and/or store information specifying that a first menu option (e.g., an option corresponding to the “4” key) in a telephonic menu should be handled in accordance with a first service model (e.g., a shared service model). In at least one arrangement, the first menu option may be mapped to a shared service model because it may be desirable to have the first menu option routed to a call center operated by a second entity, if such a call center is available. This may be desirable in some instances, because the first menu option may represent an up-sell opportunity for the second entity in which the second entity may be able to sell additional goods or services to the caller and/or provide more personalized or more responsive service to the caller. For example, the first menu option may correspond to a request to load additional funds onto a stored value card, which may represent an up-sell opportunity to a bank or financial services company that issued the stored value card, as the bank or financial services company may be able to provide the caller with additional goods or services while the caller is loading additional funds onto the stored value card.

In step 815, a second option in a telephonic menu may be mapped to a second service model. For example, in step 815, the voice response unit may receive and/or store information specifying that a second option (e.g., an option corresponding to the “7” key) in a telephonic menu should be handled in accordance with a second service model (e.g., a full-service model) different from the first service model.

In step 820, the configuration settings specified during the configuration mode may be saved. For example, in step 820, the voice response unit may store (e.g., in the menu options database 290) and/or otherwise save settings specified during the configuration mode, such as settings defining the telephonic menu. These settings may include, for instance, settings defined in steps 810 and 815 specifying that the first menu option in the telephonic menu is to be mapped to the first service model and further specifying that the second option in the telephonic menu is to be mapped to the second service model.

In step 825, an incoming call may be received. For example, in step 825, the voice response unit may receive an incoming telephone call from a user, who may also be referred to as the “caller.”

In step 830, an introduction to a menu may be generated. The menu may comprise a plurality of menu options. For example, in step 830, the voice response unit may generate the introduction to a menu to the caller by playing one or more audio segments or audio prompts to the caller over the telecommunications network. As discussed above, the audio segments or audio prompts may provide the caller with various forms of information, ask the caller to press particular keys to select options within the telephonic menu, or serve other functions.

In step 835, a plurality of menu options may be provided, including a first menu option and a second menu option. The first menu option can provide a first force transfer to a first call service center and a second menu option in the plurality of menu options can provide a second force transfer to a second call service center. For example, in step 835, the voice response unit may provide the plurality of menu options by playing one or more audio segments or audio prompts to the caller over the telecommunications network. As discussed above, the audio segments and/or audio prompts may provide the caller with various forms of information, ask the caller to press particular keys to select options within the telephonic menu, and/or serve other functions.

In step 840, it may be determined whether the first menu option was selected. For example, in step 840, the voice response unit may determine whether the caller pressed a key corresponding to a selection of the first menu option (e.g., by determining whether a particular DTMF tone corresponding to the key was detected over the telephone connection).

If it is determined, in step 840, that the first menu option was selected, then in step 845, the voice response unit may initiate a first force transfer to a first call service center. In an embodiment, the first call service center may be selected based on one or more routing factors (e.g., in accordance with the first service model, which may be a shared-service model). As discussed above, these routing factors may include the day of the week, the time of day, call center availability (e.g., based on the date or time of the call), estimated wait times at different call centers, or other factors. Thus, in one example, the voice response unit may select a second call center to route the call to if the current time is within the operating hours of the second call center (e.g., where the second call center may be operated by a second entity, such as a client or business partner of first entity), and the voice response unit may select a first call center to route the call to if the current time is not within the operating hours of the second call center (e.g., where the first call center may be operated by a first entity, such as the payment processing network). Subsequently, the voice response unit may transfer the call to the call center selected.

On the other hand, if it is determined, in step 840, that the first menu option was not selected, then in step 850, it may be determined whether the second option was selected. The second menu option may be subsequent to the first menu option in the plurality of menu options. For example, in step 850, the voice response unit may determine whether the caller pressed a key corresponding to a selection of the second option (e.g., by determining whether a particular DTMF tone corresponding to the key was detected over the telephone connection).

If it is determined, in step 850, that the second option was selected, then in step 855, the voice response unit may initiate a second force transfer to a second call service center. In an embodiment, the second call service center may be selected based on one or more routing factors, similar to the routing factors considered in association with step 845. In an embodiment, the call may be routed to a particular call center (e.g., in accordance with the second service model, which may be a full-service model). In some instances, this call center may be referred to as a “managed” call center, because in accordance with the full-service model, the call center may be managed by the same entity that has deployed the voice response unit, such as the payment processing network or second entity in the examples above. Thus, in one example, the voice response unit may, in step 855, transfer or otherwise route the call to a particular call center, which may be managed by the same entity that has configured or deployed the voice response unit (e.g., the payment processing network).

On the other hand, if it is determined, in step 850, that the second option was not selected, then in step 860, the computing device may continue processing the call. For example, in step 860, the voice response unit may continue providing the telephonic menu to the caller and/or may process any other user selections that might be made (e.g., in response to one or more prompts included in the telephonic menu).

Subsequently, in step 865, the connection may be closed. For example, in step 865, after the call has been routed (e.g., in step 845 or in step 855) or after the call has been otherwise processed (e.g., in step 860), the voice response unit may close the telephone connection or otherwise end the telephone call (e.g., when the caller hangs up).

Thereafter, in step 870, subsequent incoming calls may continue to be handled. For example, in step 870, the voice response unit may continue to handle incoming calls (e.g., by performing one or more steps of the example method, as described above).

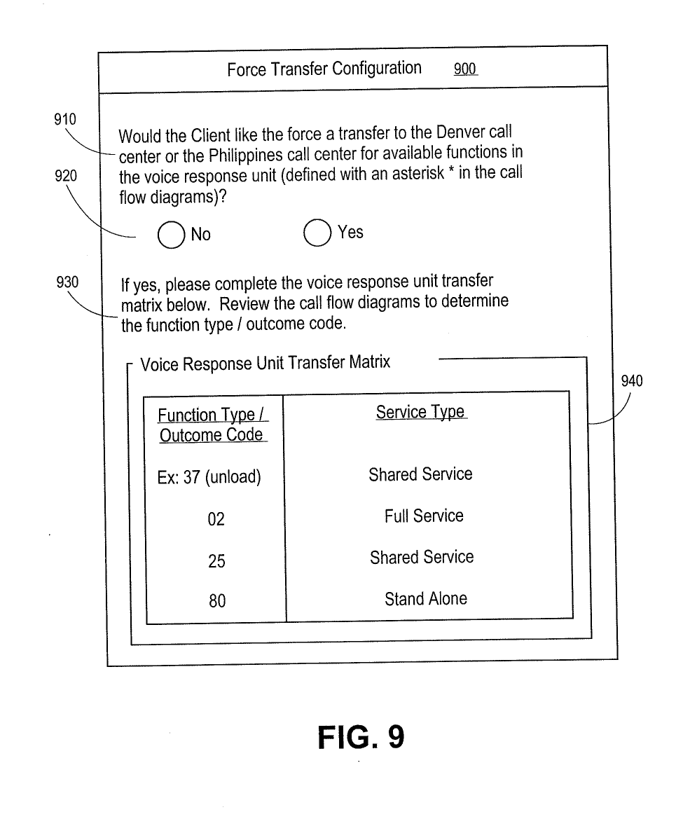

FIG. 9 shows a graphical user interface (GUI) 900 for configuring a force transfer in accordance with some embodiments. For example, the force transfer configuration GUI 900 can be implemented as a dialog box, a spreadsheet, or a web page that asks the user if they would like to customize a forced transfer. When a spreadsheet is used, the user may provide explanations and descriptions in spreadsheet form and implement the instructions from the spreadsheet into the database(s). The dialog box may pose a question 910 like “would the Client like to force a transfer to the Denver call center or the Philippines call center for available functions in the voice response unit (defined with an asterisk * in the call flow diagrams)?” The force transfer configuration GUI 900 may also include a response section 920 for the user to provide a response. The response section can be a text box for the user to fill in a response (e.g., typing “yes”), a radio button to allow the user to select their response, or any other method known in the art.

The force transfer configuration GUI 900 may also offer a follow up question 930. For example, if the response from the user is “yes,” noting that the user would like to force a transfer to the Denver call center or the Philippines call center, then the dialog box may provide a follow up question 930 like: “If yes, please complete the voice response unit transfer matrix below. Review the call flow diagrams to determine the function type/outcome code.” The voice response unit transfer matrix 940 can provide a matrix to the user, which associates a function type or outcome code with a service type. The user can provide a desired function type or outcome code (e.g., “02,” “25,” and “80”) and correlate them with a service type (e.g., “full service,” “shared service,” and “stand alone,” respectively). The user may correlate function types to service types. Each function type that is configured to force transfer may specify the service type independently. This may be similar to the information that is stored in the service type database, as shown in FIG. 4.

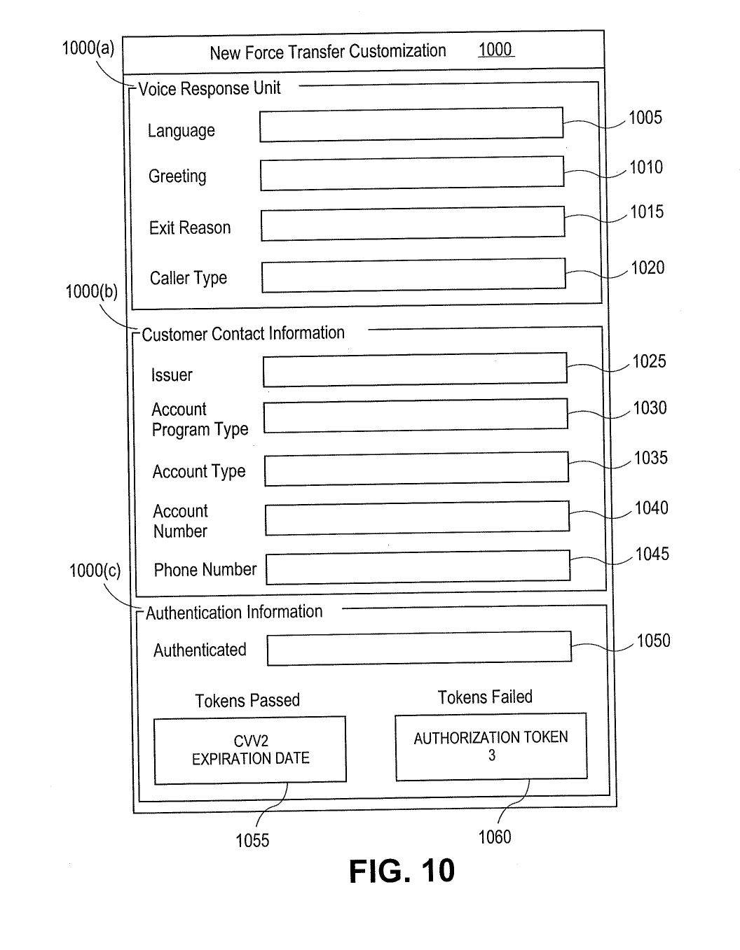

FIG. 10 shows a GUI 1000 that illustrates a customization menu for creating a new force transfer in accordance with some embodiments. The new force transfer customization GUI 1000 can be provided to users and contain information about a particular call, including information associated with the voice response unit 1000(a), customer contact information 1000(b), and authentication information 1000(c).

In an embodiment, each section of information can include a subheading and text box to provide information by the user.

Information associated with the voice response unit 1000(a) can include several subheadings, including language 1005, greeting 1010, exit reason 1015, and caller type 1020. Each subheading can have a corresponding text box for the user to provide information. For example, exit reason 1015 may provide the CSR with a reason why the caller exited the VRU (e.g., what caused the initiation of a forced transfer) and a unique exit reason 1015 can exist for each function type (e.g., “02,” “25,” and “80” as shown above, or a textual explanation in the form of a string of characters). For example, the information provided in greeting 1010 can be “Hero Card” and the information provided in caller type 1020 can be “card holder” or “account holder.” This information may be stored in the profiles database in FIG. 5 or provided by the CSR.

Customer contact information 1000(b) can include several subheadings and corresponding text boxes as well, including issuer 1025, account program type 1030, account type 1035, account number 1040, and phone number 1045. For example, the information provided in association with issuer 1025 subheading can be an issuer, (e.g., “Chase”). The information provided in association with account program type 1030 can be the type of account program associated with the customer (e.g., gift card). Information can also be left blank in association with each subheading. A customer's account number (e.g., 4100 0000 359) can be provided in association with account number 1040. Further, a customer's phone number (e.g., 800-557-5309) can be provided for phone number 1045. The customer's phone number provided in phone number 1045 can be a toll free number (TFN).

Authentication information 1000(c) can include whether the customer contact information was authentication 1050 (e.g., yes or no) and which tokens, if any, passed or failed. For example, Tokens Passed 1055 may include “CVV2” and “Expiration Date” and Tokens Failed 1060 may include “Authorization Token 3.”

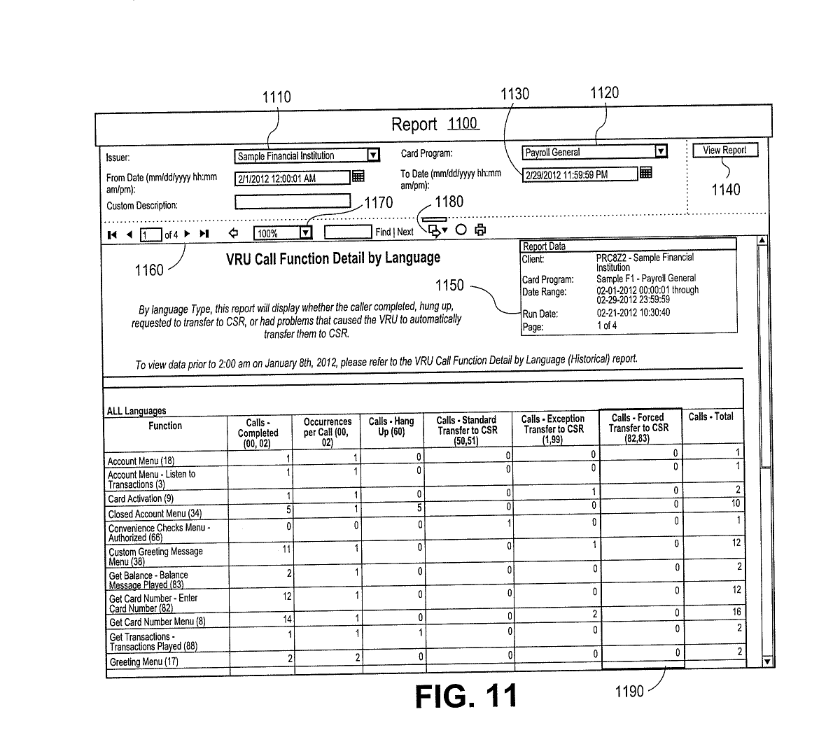

FIG. 11 illustrates a report displaying a summary of calls received by the voice response unit during a particular time period in accordance with some embodiments. The report 1100 can provide a way to visually represent information associated with the voice response unit (e.g., the call function detail by language, or system statistics by language). The report 1100 may provide or sort information related to a particular issuer 1110, account program 1120, date range 1130, or any other custom description. The report 1100 may also include a button 1140 used to generate the report based on the options selected.

The generated report can include a summary of the options selected 1150. For example, the summary of options selected 1150 can provide the name of the user (e.g., “PRCB22—Sample Financial Institution”), the account program selected (e.g., “Sample FI—Payroll General”), date range (e.g., “02-01-2012 00:00:01 through 02-29-2012 23:59:59”), run date (e.g., “02-21-2012 10:30:40”), and the page displayed in the report (e.g., “1 of 4”). The report may also include navigation and viewing tools, including a navigator to select or scroll to other pages in the document 1160, a zoom option 1170, and one or more report options 1180 (e.g., save as, export to a file, refresh, or print).

The report may also include information displayed in a matrix format by function type. For example, as shown in column 1190, the report can display information related to the calls that are forced to transfer to a particular call service center that used function type or output codes “82” or “83.” In this column, no calls were forced to transfer to the particular call center based on options 82 or 83 from account menu (18), account menu—listen to transactions (3), account activation (9), closed account menu (34), convenience checks menu—authorized (66), custom greeting message menu (38), get balance—balance message played (83), get account number—enter account number (82), get account number menu (8), get transactions—transactions played (88), greeting menu (17), etc.

Information may also be provided for statistical analysis. For example, the report may illustrate that 9% of all calls resulted in forced transfers out of 11 calls total, or callers spent 2.53 minutes in the VRU on average.

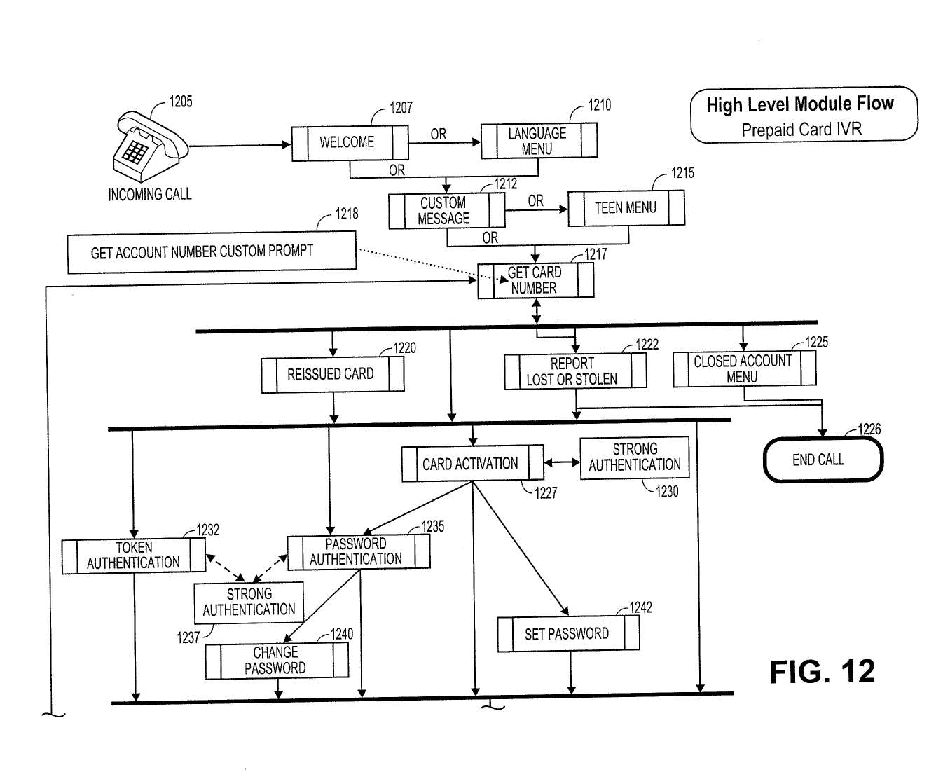

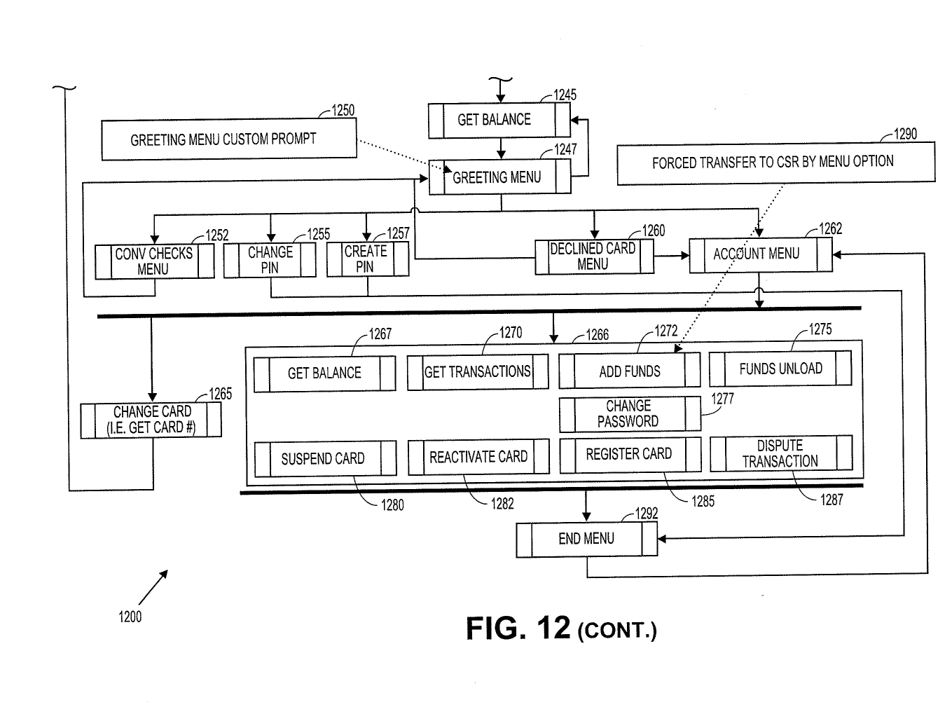

FIGS. 12-14 are simplified flow diagrams that illustrate optimized VRU functionalities according to one or more aspects of the disclosure. For example, FIG. 12 is a simplified flow diagram that illustrates the voice response unit functionalities in accordance with some embodiments. Also, FIG. 12 can illustrate an example high-level flow of how an incoming call may be processed by a voice response unit and how one or more telephonic menus may be presented to the caller by the voice response unit. In addition, FIG. 12 can illustrate how an “Add Funds” request may be mapped to a function that causes the voice response unit to transfer the call to a customer service representative.

The method 1200 can begin in step 1205 when the voice response unit receives an incoming call. For example, a caller 110 may use a telephone 110(a) to communicate with a VRU over a telecommunications network.

In step 1207, a welcome message may be provided. The welcome message can be provided to the caller by the voice response unit by playing a pre-recorded message. After the welcome message is provided, the method 1200 can proceed to either step 1210 or step 1212.

In step 1210, the method may provide a plurality of menu options that correspond to various languages. The method may proceed to step 1212.

In step 1212, the custom message may be provided in a specific language. For example if in step 1210, the caller selected the menu option corresponding to Spanish language, the custom message can be provided to the caller in Spanish. Relevant databases may also be updated. For example, the profiles database 285 can reflect that the caller prefers Spanish or the activity log database 295 can be updated with the amount of time the user has spent in the VRU before the Spanish option was selected. The method can proceed to step 1215 or step 1217.

In step 1215, a teen menu may be provided. For example, menu options may be provided when the age of the accountholder may be an issue. One menu option may be “if you are the parent or guardian of the accountholder, press 1” or “if you are the teen accountholder, press 2.” The method may proceed to step 1217.

In step 1217, the voice response unit can receive an account number. The card number can be a primary account number associated with a payment device, or other identifying information associated with the caller. In an embodiment, a custom recorded prompt 1218 aimed at getting the card number can be provided. After step 1217, the method can proceed to step 1220 for a reissued card, step 1222 to report a lost or stolen card, step 1225 for a closed account, step 1227 to activate a card, step 1232 to activate a token, step 1235 to authenticate a password, or step 1245 to get the card balance.

In step 1220, the method may provide a prompt related to a reissued card. The method may request the expiration date associated with the card that the caller is calling about. In step 1220, the method may also determine whether the caller is providing the card number for his original card or his reissued card, which may need to be activated later in the process or authenticated. The method may proceed to step 1232 to authenticate a token, step 1235 to authenticate a password, step 1227 to activate a card, or step 1245 to get the card balance.

In step 1222, the method may provide a menu prompt relating to reporting a lost or stolen card. For example, the recorded prompt can be “to report a lost or stolen card, press 1” or a customized prompt message related to menu option 2. The method may proceed to step 1226 to end the call.

In step 1225, a closed account menu may be provided (e.g., “The card number you entered is closed. To speak with a representative, press 0. To end this call, press 9 or simply hang up.”). The method may proceed to step 1226 to end the call.

In step 1227, the voice response unit can prompt the caller to activate a card. For example, the method may provide an introduction (e.g., “Before this card can be used it must be activated. You can activate it now by providing the following information.”). The method may then prompt the user to provide a primary account number, card holder's zip code, phone number, or any other information relevant to activating a new card. The method can proceed to step 1230 to prompt the caller for a strong authentication, step 1235 to authenticate a password, step 1242 to set a password, or step 1245 to get the card balance.

In step 1235, a password authentication prompt may be provided. For example, the method may provide a menu option stating “to verify your identity, please enter your password.” Another menu option may be “to maintain the security of your account, we suggest that you change your password” or “please hold while I obtain the information on this account.” The card may be validated based on the information provided. The method can proceed to step 1237 to prompt the caller for a strong authentication, step 1240 to change the password, or step 1245 to get the card balance.

In step 1232, a token authentication prompt may be provided. For example, the method may provide a menu option stating “to verify your identity, enter the specific security token now.” An example of a specific security token may be the last four digits of the caller's social security number, the last four digits of the caller's phone number associated with the account, a zip code, CVV2 (e.g., security card code), expiration date, etc. The method can proceed to step 1237 to prompt the caller for a strong authentication or step 1245 to get the card balance.

In step 1237, a strong authentication prompt may be provided. For example, the method may provide a menu option stating “enter the three digit security code located on the back of your card now.” The method can return to step 1232 or step 1235.

In step 1240, a change password prompt may be provided. For example, the method can provide “to change the password for this account, enter the current password followed by the pound key.” When the caller provides the response to the prompt, the VRU may confirm that the new password should be between a minimum (e.g., 4 digits) and a maximum (e.g., 8 digits) long if it is defined by the user. The menu option can also provide follow up prompts, like “the new password must be between 4 and 8 digits in length; please enter a new password” or “please enter the new password now.” The method can proceed to step 1245 to get the card balance.

In step 1242, a set password prompt can be provided. For example, the method may play a pre-recorded message that instructs the caller to set a new password (e.g., “Create a numerical password for future access to this system that is between 4 and 8 digits in length. Please enter the new password now”). The method can proceed to step 1245 to get the card balance.

In step 1245, the voice response unit can provide the caller with the card balance. For example, the method may state “as of the current date, the available balance on this account is one-hundred dollars” or provide information when funds may be loaded onto the account. The method can proceed to step 1247.

In step 1247, the method can provide a greeting menu. For example, the method may provide an introduction (e.g., “if you know your selection, you may enter it at any time during this call. Please select from the following menu options.”) or provide a menu option immediately without an introduction. Examples of menu options may include “to hear the available balance, press 1,” “to create or change the PIN on this account, press 2,” “to request convenience checks, press 3,” “if your card has been declined, press 4,” etc. Another menu option may be “to speak with a representative, press 0.” In an embodiment, the greeting menu in step 1247 may be a custom prompt 1250. For example, the user may generate a menu prompt that relates to lost or stolen cards, in order to direct these callers directly to a call center with a skill set that relates to lost or stolen cards (e.g., fraud mitigation).

After step 1247, the method may return to step 1245 to get the card balance, or proceed to other menu options, including step 1252 relating to checks, step 1255 to change a personal identification number (PIN), step 1257 to create a PIN, step 1260 relating to the declining card menu, or step 1262 for the account menu.

In step 1252, the method may provide menu options relating to authorizing or requesting convenience checks. For example, the prompt may state “to authorize convenience checks, press 1,” “to request convenience checks, press 2,” “to repeat these options, press 3,” etc. In embodiments of the invention, the menu options can be customized so that when the caller selects menu option 1, the activity log module can process or store the action in the activity log database (e.g., set ent_exitpoint=“AuthorizeChecks”) and the caller can be force transferred to a call center (e.g., if the user wants to attempt to sell additional services to the caller related to convenience checks, instead of allowing the caller to proceed through automated menu options). The method can return to step 1247 to provide a greeting menu.

In step 1255, the method may provide menu options related to changing the caller's PIN (e.g., personal identification number). For example, the prompt can be “to change your PIN, enter your current PIN followed by the pound key.” Various customization points can be selected by the user in this and any other menu as well. The method can proceed to can proceed to step 1292 to provide the end menu.

In step 1257, the method may provide menu options related to creating a PIN (e.g., “You have requested a new personal identification number. Your PIN should be numerical and be four digits in length. Please enter your PIN followed by the point key.”). The method can proceed to can proceed to step 1292 to provide the end menu.

In step 1260, a declined card menu can be provided. For example, the menu options may relate to pre-recorded prompts for receiving more information about a declined card that the caller is reporting (e.g., “if your card was recently declined at a merchant, press 1,” “during an internet purchase, press 2,” “at a gas station, press 3,” or “at a restaurant, press 4”). The method can proceed to step 1262 to the account menu or back to step 1247 for the greeting menu.

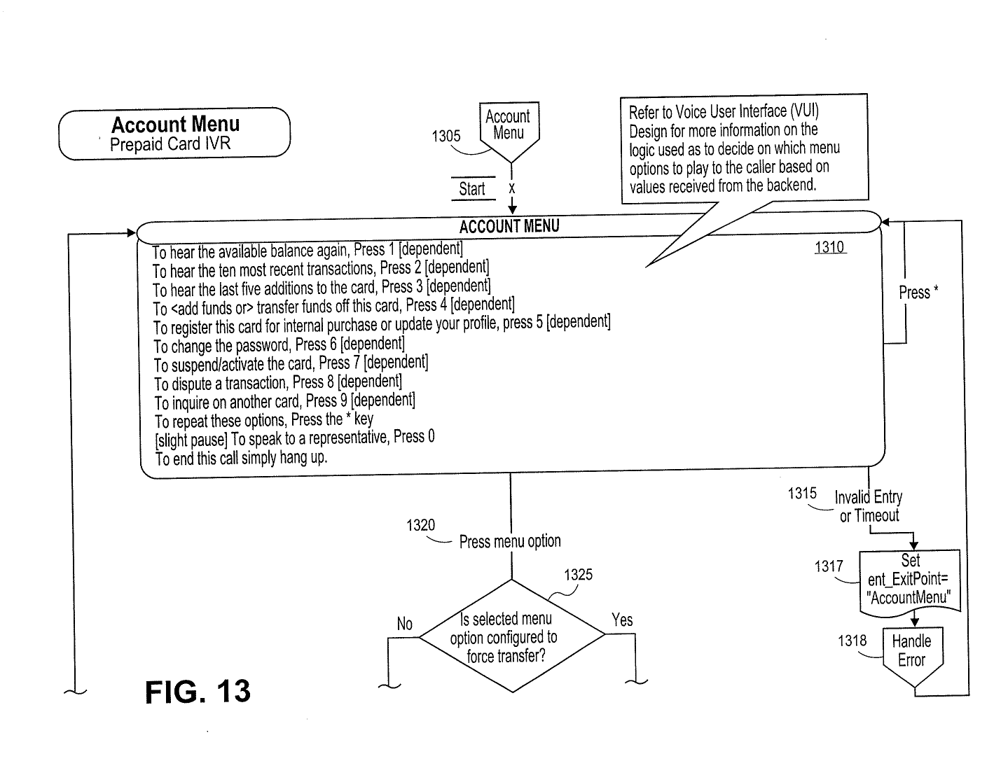

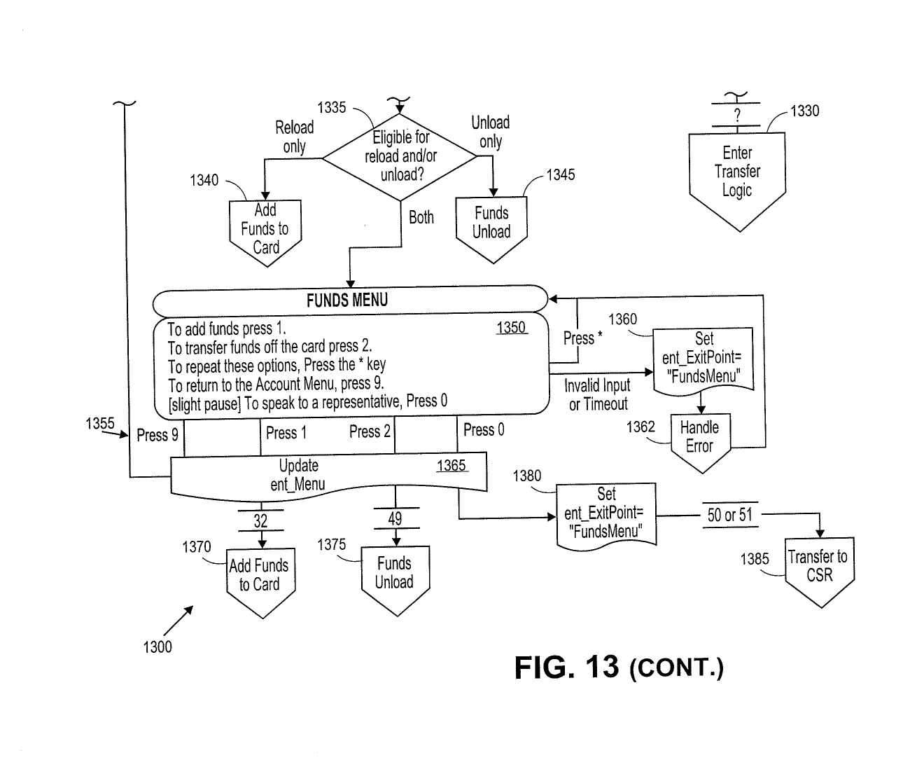

In step 1262, the voice response unit can provide an account menu. An example of an account menu is show in greater detail in FIG. 13. Step 1262 can proceed to step 1265 to provide the change card prompt (e.g., get card number) or step 1266 to provide a plurality of menu options. The plurality of menu options 1266 can include step 1267 to get balance, step 1270 to get transactions, step 1272 to add funds, step 1275 to unload funds, step 1277 to change a password, step 1280 to suspend use of the card, step 1282 to reactivate the card, step 1285 to register the card, or step 1287 to dispute a transaction. In an embodiment, step 1272 may correspond with a force transfer by menu option 1290.

In step 1265, a change card prompt can be provided. After step 1265, the method may proceed to step 1217 to the get card number prompt.

In step 1267, a similar prompt may be provided as in step 1245. The method may proceed to step 1292.

In step 1270, a prompt relating to the transactions can be provided. The method may query a voice response database to retrieve information about pending or completed transactions in order to provide the information to the caller. For example, if no transactions are retrieved from the databases, the prompt may be “there are no transactions pending or posted for this account.” The method may proceed to step 1292.

In step 1272, a menu option to add funds may be provided. For example, the method can remind the caller which account can receive the funds (e.g., “the primary account on file ending in 0001 can be used to fund this card”), accept the amount that the caller would like to add (e.g., “please enter the amount you wish to fund in dollars and cents followed by the pound key. For example, for thirty dollars, please enter three, zero, zero, zero.”), confirm the amount (e.g., “You have entered the amount of forty-five dollars. If this is correct, press 1. If this is incorrect, press 2.”), or customized to provide other menu options and prompts, including forced transfer. The method may proceed to step 1292.

In step 1275, the method may provide menu options relating to transferring funds. For example, the menu options can allow the caller to select an account to start a transfer from, select an account to send a transfer to, provide an applicable amount to transfer, handle errors, confirm the amount, and process the request. The method may proceed to step 1292.

In step 1280, menu options may be provided to suspend a card. For example, an introduction with menu options can be provided (e.g., “You have requested to suspend your card. Please note that by doing so you cannot be able to use this card for purchases or withdrawals. To confirm this request, press 1. To cancel this request, press 2.”). Databases may be updated with the card status (e.g., profiles database, card database, activity log database, etc.) to process the caller's request. The method may proceed to step 1292.

In step 1282, a reactivation card menu option may be provided (e.g., “You have requested to activate this card. Once you have activated your card, you can begin using it immediately. To confirm press 1. To cancel press 2.”). The method may proceed to step 1292.

In step 1292, the voice response unit can provide an end menu. For example, menu options may be provided to return to the previous menu (e.g., “to return to the previous menu, press 1”), transfer to a CSR (e.g., “to speak with a representative, press 0”), or end the call (e.g., “to end this call, press 9 or simply hang up”). After step 1292, the method may return to step 1262 to provide the account menu.

FIG. 13 is a flow diagram that illustrates an account menu, a plurality of menu options that the caller may choose, and a force transfer as a result of choosing particular menu options in accordance with some embodiments. FIG. 13 can also illustrate an example telephonic menu that includes a plurality of options that allow a caller to manage an account. For instance, a voice response unit may provide the example telephonic menu illustrated in FIG. 13 to a caller that requests to obtain and/or modify various aspects of an account, such as an account holder account maintained with a tax accounting firm and/or serviced by a payment processing network. As seen in FIG. 13, a user selection of certain options may result in the call being transferred to a customer service representative (e.g., in accordance with transfer logic, such as one or more service models).

The method 1300 may begin with step 1305 by providing an account menu. Step 1305 may correspond with step 1262 from FIG. 12.

In step 1305, an account menu may be provided. The account menu can contain a plurality of menu options 1310, which contain prompts that ask the caller for a response. For example, one of the menu options can be “to hear the available balance again, press 1.” This menu option can correspond with step 1267 from FIG. 12. Another menu option can be “to hear the ten most recent transactions, press 2,” which can correspond with step 1270. Another menu option can be “to hear the last five additions to the card, press 3,” which can correspond with step 1272. Another example of a menu option may be “to add funds or transfer funds off this card, press 4,” which can correspond with step 1275. In another example, the menu option may provide “to register this card for internet purchase or update your profile, press 5,” which can correspond with steps 1282 or 1285. Another menu option can be “to change the password, press 6,” which can correspond with step 1277. Another example may be “to suspend/activate the card, press 7,” which may correspond with step 1280. In yet another example of a menu option in the account menu, “to dispute a transaction, press 8,” which can correspond with step 1287. A further menu option may be “to inquire on another card, press 9,” which can correspond with step 1265, or “to repeat these options, press the * key.” The plurality of menu options may provide the aforementioned examples in subsequent order to each other. The menu options may also provide an opportunity to speak with a representative (e.g., “to speak with a representative, press 0”) or end the call (e.g., “to end this call simply hang up”). The caller may also be returned to the account menu by pressing a valid option (e.g., pressing the * (asterisk) key).

In step 1320, a caller may select a menu option via the telephone. If the response received from the caller is a valid response, the voice response unit may proceed to step 1325. If the response is invalid (step 1315), the voice response unit may proceed to step 1317 by communicating information about the invalid response or storing details about the invalid response in a database (e.g., set ent_exitpoint=“AccountMenu”), and processing the error in step 1318.

In step 1318, the method may handle an error. For example, the method may maintain an error counter which can increment with each error that the method experiences for a caller. If an error is triggered, the method may provide an error prompt and update the activity log database with the error encountered. The method may proceed back to the account menu and provide the plurality of menu options 1310.

In step 1325, the method may determine if the selected menu option by the caller is configured to force a transfer (e.g., to a call center). This may be a decision point in the call flow to determine whether the selected menu option is configured for a forced transfer based on a customized call flow provided by the user prior to the call. If the selected menu option is configured to force a transfer, the method can proceed to step 1330. If the selected menu option is not configured to force a transfer, the method can proceed to step 1335.

In step 1330, the method can enter the transfer logic portion of the voice response unit, as further illustrated in FIG. 14.

In step 1335, the method can determine how to proceed with the selected menu option. For example, if the caller selected the menu option to reload and/or unload funds from the card, the method can determine whether the associated card or caller is eligible for reload and/or unload in step 1335. If eligible for reload and the caller selected the reload menu option, the method may add funds to the card in step 1340. If eligible for unload, the method may unload funds in step 1345. If eligible for both, the method may proceed to step 1350.

In step 1350, the method may provide a funds menu. The funds menu can contain a plurality of menu options, which contain prompts that ask the caller for a response. For example, one of the menu options can be “to add funds, press 1.” Other menu options can be “to transfer funds off the card, press 2,” “to repeat these options, press the * key,” and “to return to the account menu, press 9.” Other menu options may be available, including directing the caller to a call center representative (e.g., “to speak to a representative, press 0”).

In step 1355, the caller may select a menu option. If the menu option is invalid or the caller takes too long to select a response (e.g., timeout, exceeding a time threshold), then the method may store details about the response in a database in step 1360 (e.g., set ent_exitpoint=“FundsMenu”) and process the error in step 1362. The method may be rerouted to the funds menu. The caller may also be returned to the funds menu by pressing a valid option (e.g., pressing the * (asterisk) key).

In step 1365, the method may store details about the response in a database (e.g., update ent_menu). The method may proceed to step 1370 to add funds, step 1375 to unload funds, step 1380 to process information, or return to the account menu.

In step 1370, the method may add funds to the card (e.g., if menu option 1 is pressed in step 1350).

In step 1375, the method may unload funds (e.g., if menu option 2 is pressed in step 1350).

In step 1380, the method may process information about the selected menu option (e.g., set ent_exitpoint=“FundMenu”). After information has been stored, the method may initiate a transfer to a call center in step 1385.

FIG. 14 is a flow diagram that illustrates a force transfer and initiating a transfer to a call service center in accordance with some embodiments. FIG. 14 can also illustrate an example method of how a call may be routed (e.g., in accordance with transfer logic and/or one or more service models) by a voice response unit. As seen in FIG. 14, various factors, such as the current time, situational circumstances, call center hours and/or holiday schedules, and/or other factors may affect the routing determination made by the voice response unit. In addition, in certain circumstances illustrated in FIG. 14, a call center may be unavailable and/or a call transfer might not be possible, in which case the voice response unit may terminate the call after playing a notification to the caller.

The method 1400 may begin with step 1402 when the method begins processing the forced transfer.

In step 1405, the method may determine whether it is configured to provide the transfer fee message. If yes, the method may proceed to step 1410. If not, the method may proceed to step 1412.

In step 1410, a prompt may be provided to the caller to provide menu options related to transfer fees (e.g., “to speak to a representative which may incur additional fees on this account, press 0. To end this call press 9 or simply hang up.”). Based on the caller's responses, the method may proceed to step 1412 (e.g., if 0 is pressed) or step 1462 (e.g., if 9 is pressed or the caller hung up).

In step 1412, the method may determine if menu option is associated with a shared service and whether the action that resulted in the transfer is configured to transfer the caller to a call center (e.g., the Denver call service center). In an embodiment, the call center may be the first call service center associated with the first entity. If yes, the method may proceed to step 1415 to determine the shared time range. If no, the method may proceed to step 1417.

In step 1415, the method may determine the shared time range. For example, the method may progress through decision points to determine if the date of the call is a holiday for the user's call center, if the date of the call is a holiday for an external call center, or whether either call center is currently open (e.g., to accept a call transfer for a currently pending call). The method may proceed to initiating a transfer to a call center and/or terminating the call in the VRU.

In step 1417, the method may determine if the transfer is associated with a stand alone service type. If yes, the method may proceed to step 1420 and if no, the method may proceed to step 1422.

In step 1420, the method may convert the system clock from the current time to a different time. For example, if the voice response unit is in the Pacific time zone and the first call service center is in the Eastern time zone, the method may convert the time of the call from Pacific to Eastern time zones. The method may proceed to step 1425.

In step 1422, the method may determine whether the call should be transferred. For example, if the caller has selected menu options that correspond with a lost or stolen card, the user may have chosen to always transfer the call to the first or second call service centers. If not, meaning the method should not transfer the call, the method may proceed to step 1425. If yes, the method may proceed to step 1452.

In step 1425, the method may determine if the current day is a holiday. If yes, the method can proceed to step 1427. If no, the method may proceed to step 1440.

In step 1427, the method may determine whether the call center is closed. For example, the hours associated with the call center may signify that it is closed (e.g., hours=“9999” in the call center database 270 or routing factors database 275). If yes, meaning that the call center is closed, the method may proceed to step 1432, or step 1430 if the call center is not closed.

In step 1430, the method may determine if the current time of the call is within the regular open and closed times of the call center. If yes, the method may proceed to step 1452 and if not, the method may proceed to step 1432.

In step 1432, the method may prepare a business hours voice segment. For example, the method may prepare to play a recording or compile information related to a verbal segment about a call center's business hours and proceed to step 1435.

In step 1435, a recording may be provided to the caller to provide the regular business hours of the call center (e.g., “the Denver call center's hours of operation are 9 am to 5 pm, Monday through Friday”). The method may proceed to step 1437.

In step 1437, the method may store details about the call in a database (e.g., set ent_exitpoint=“Term” and set ent_callendtime). The method may proceed to step 1465.

In step 1440, the method may determine if the call center is closed, even though the date of the call is a holiday. If yes, the method can proceed to step 1450 to provide a recording to inform the caller that the call center is closed after a holiday. If no, the method can proceed to step 1442.

In step 1442, the method can determine if the current time of the call is within the holiday open and closed times of the call center. If yes, the method may proceed to step 1452 and if no, the method may proceed to step 1445.

In step 1445, the method can determine whether the current time of the call is before the holiday open time of the call center. If yes, the method may proceed to step 1447 to provide a recording to inform the caller that the call center is closed before a holiday. If not, the method can proceed to step 1450 to provide a recording to inform the caller that the call center is closed after a holiday. After either step 1447 or step 1450, the method can proceed to step 1462.

In step 1452, the method may determine if the transfer corresponds with a stand alone service type. If no, the method may proceed to step 1455 to make a route request to transfer the call, and then to step 1465. If yes, the method can proceed to step 1457.

In step 1457, the method may process information about the status of the call (e.g., set ent_exitpoint=“XTran” and ent_callendtime). After information has been stored, the method may initiate a transfer to a financial institution or call center in step 1460, and then proceed to step 1465.

In step 1462, the method can process information about the status of the call (e.g., set ent_exitpoint=“Term” and ent_callendtime). After information has been stored, the method may proceed to step 1465.

In step 1465, the method may initiate additional processes before the method ends the call (e.g., LogCallRequest) this information may be used to update the activity log database 295 and archive information about the call. The method may proceed to step 1467 to end the call.

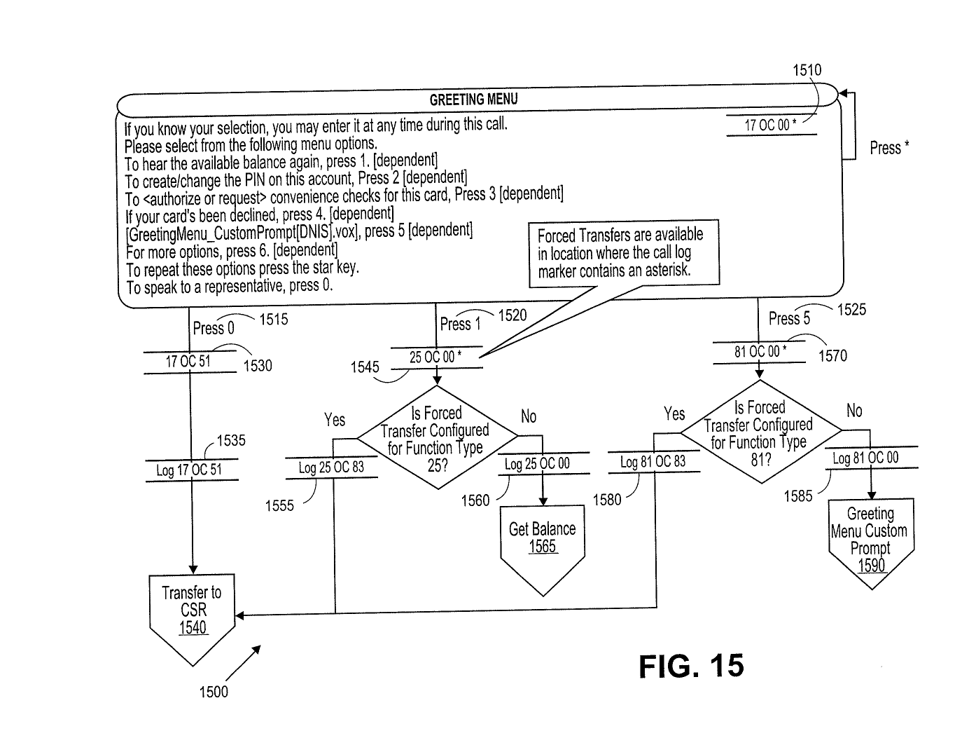

FIG. 15 illustrates a customizable flow diagram for initiating a force transfer in accordance with some embodiments. FIG. For example, future calls can be forced transferred when the call flow diagram shows an asterisk (*) above a decision block.

The method 1500 may begin by generating an introduction to a menu. The introduction to a menu can provide a plurality of menu options 1505, which contain prompts that ask the caller for a response. For example, the greeting menu can being with an introduction (e.g., “if you know your selection, you may enter it at any time during this call. Please select from the following menu options.”). One of the menu options can be “to hear the available balance again, press 1.” Another menu option can be “to create or change the PIN on this account, press 2.” Another menu option can be “to authorize or request convenience checks for this card, press 3.” Another example of a menu option may be “if your card has been declined, press 4.” In another example, the menu option may provide a custom prompt as a menu option by playing a pre-recorded audio file for the caller (e.g., GreetingMenu_CustomPrompt.vox). Another menu option can be “for more options, press 6.” Other menu options may be “to repeat these options, press the star key” or “to speak with a representative, press 0.” The plurality of menu options may provide the aforementioned examples in subsequent order to each other. The greeting menu may be customized, as shown by asterisk 1510. For example, the menu can comprise a plurality of menu options including a first menu option and a second menu option (e.g. “1” is a first menu option and “5 is a second menu option). The method may proceed to steps 1515, 1520, or 1525.

In step 1515, the caller may select a menu option (e.g., “0”) using his or her telephone, which can transmit the selected menu option over the telecommunications network to the voice response unit, and proceed to step 1530.

In step 1530, the selected menu option provided by the caller can correspond to stored menu options in the voice response system (e.g., selecting 0 in response to the greeting menu, corresponds with “17 OC 51” as an instruction to the VRU on how to process the response). The method may proceed to step 1535 and then to step 1540.

In step 1535, the method may log(e.g., store information in a database) related to the caller's response or the stored menu option.

In step 1540, the method may transfer the call to a call service center.

In step 1520, the caller may select a different menu option (e.g., “1”). In contrast to step 1515, this menu option can provide the user with the opportunity to customize the flow of the call. For example, the user may have customized a forced transfer to the first call service center or second call service center, which may be similar to the method shown in FIG. 14. The method may proceed to step 1545.

In step 1545, the selected menu option provided by the caller can correspond to stored menu options in the voice response system (e.g., selecting 1 in response to the greeting menu, corresponds with “25 OC 00”). In this example, “1” or “25 OC 00” would be a first menu option in the plurality of menu options that provides a first force transfer to a first call service center (e.g., a tax accounting firm's call center, the Denver call center). The asterisk in the corresponding instruction can signify that the menu option or transfer is customizable. The method may proceed to step 1550.

In step 1550, the method may determine if a forced transfer is configured for the function type of the particular menu option selected. In some embodiments, a similar analysis may be invoked when the selected menu option corresponds with a customizable call flow. In general, the step can determine if the method has been configured to force a transfer or force a call termination. For example, when the selected menu option 1 corresponds with “25 OC 00,” the function type may be “25” and 25 may correspond with a forced transfer. If yes (e.g., “25” corresponds with forced transfer), the method may log the stored menu option in step 1555 (e.g., log 25° C. 83) and proceed to step 1540. If not, the method may log the stored menu option in step 1560 (e.g., log 25 OC 00) and proceed to step 1565.

In step 1565, the method may get the balance of the card. In embodiments where a forced transfer has not been configured, step 1565 can signify to the method to continue processing the call within the standard call flow or end the call.

In step 1525, the caller may select a menu option (e.g., “5”). As shown in relation to step 1520, this menu option may also provide the user with the opportunity to customize the flow of the call.

In step 1570, the selected menu option provided by the caller can correspond to stored menu options in the voice response system (e.g., selecting 5 in response to the greeting menu, corresponds with “81 OC 00”). In this example, “5” or “81 OC 00” would be a second menu option in the plurality of menu options that provides a second force transfer to a second call service center (e.g., a second entity's call center, the Philippines call center). The method may proceed to step 1575.

In step 1575, the method may determine if a forced transfer is configured for the function type of the particular menu option selected. For example, when the selected menu option 5 corresponds with “81 OC 00,” the function type may be “81” and 81 may correspond with a forced transfer. If yes (e.g., “81” corresponds with forced transfer), the method may log the stored menu option in step 1580 (e.g., log 81° C. 83) and proceed to step 1540. If not, the method may log the stored menu option in step 1585 (e.g., log 2815 OC 00) and proceed to step 1590.

In step 1590, the method may provide a customized greeting menu prompt and continue to process the call or end the call.

The following table illustrates an example use case in which a voice response unit may provide enhanced functionality:

| | Menu Option Forced Transfer to a Customer |
|---|---|
| | Service Representative (CSR) Use Case: Add Funds |
| Use Case Name | Up-Sell Call Flow |
| Scope | Account holder calls into the second entity's VRU and |
| | decides to add funds to their card |
| Level | User |
| Primary Actor(s) | Account holder/VRU User |
| Application | Second entity's VRU |
| Account Program(s) | All Programs |
| Precondition(s) | The account holder has used an application and |
| | now has an account. |
| | The VRU has been accessed by a customer. |
| | The VRU system is operationally available. |
| | The account holder has an interaction point on the |
| | account menu that prompts the user to press ‘4’ to |
| | add funds to their account. |
| Success Guarantee | The account holder is successfully transferred to a |
| | CSR (either first entity's CSR or second entity's |
| | CSR based upon hours of operation) for more |
| | information about adding funds. |
| Trigger | The account holder calls the VRU and chooses the |
| | option to add funds to their account. |
| Main Success Scenario | When the account holder presses ‘4’ to add funds, they |
| | are transferred to either a first entity's CSR for up-sell |
| | opportunity or to a second entity's CSR (with standard |
| | script information) based upon call center hours of |
| | operation. |
| Exceptions/Alternates | |
| E1 | The second entity's VRU system is down. |
| Second entity's VRU system | |
| down | |
| E1 Result | The system can be accessed only when available. |
| | There are no new additional considerations. |
| E2 | Account holder incorrectly presses 1, 2, 3, 5, 6, 7, 8, or |
| Account holder presses 1, 2, | 9 (user error). |
| 3, 5, 6, 7, 8 or 9 | |
| E2 Result | The account holder can be directed thru the |
| | appropriate menu logic based upon their respective |
| | menu choice. |
| E3 | Account holder incorrectly presses 0 (user error) and |
| Account holder presses 0 | can be routed to the call center. |
| E3 Result | The CSR can inform the account holder of the standard |
| | refund message information. |
| E4 | Account holder incorrectly presses an invalid key |
| Account holder presses | combination (user error) or presses nothing (timeout). |
| invalid entry or timeout | |
| E4 Result | The existing Handle Error Flow can accommodate this |
| | scenario. |

Various embodiments of the invention, as described herein, have a number of advantages over the prior art and currently existing systems. For example, by mapping options in a telephonic menu provided by a voice response unit to distinct service models (instead of simply mapping these options to specific call centers), increased customizability may be provided to entities that deploy, implement, and/or otherwise use voice response units. This, in turn, may allow these entities to operate more efficiently and/or utilize fewer resources, as optimized service models may be defined and used in call routing by voice response units, where such optimized service models are designed to most efficiently use the most desirable/specialized resources (e.g., to provide customer service), which in turn may generate greater sales opportunities and increased revenues.

Embodiments of the invention are also advantageous because the voice response unit is dynamic where prior art and currently existing systems are static. Embodiments can easily integrate a user's customization needs, like including one or more call centers without excessive retooling and reconfiguration.

The software components or functions described in this application may be implemented as software code to be executed by one or more processors using any suitable computer language, such as Java, C++, or Perl, for example, using conventional and/or object-oriented techniques, for instance. The software code may be stored as a series of instructions and/or commands on a computer-readable medium, such as a random access memory (RAM), a read-only memory (ROM), a magnetic medium (e.g., a hard drive, a floppy disk, etc.), and/or an optical medium (e.g., a CD-ROM). Any such computer-readable medium also may reside on and/or within a single computational apparatus, and further may be present on and/or within different computation apparatuses with a system or network.

Aspects of the disclosure can be implemented in the form of control logic in software or hardware or a combination of both. The control logic may be stored in an information storage medium as a plurality of instructions adapted to direct an information processing device to perform a set of steps disclosed herein. Based on the disclosure and teachings provided herein, a person of ordinary skill in the art will appreciate other ways and/or methods to implement the present invention, and these other ways and/or methods are within the scope and spirit of the presentation disclosure.

In some embodiments, any of the entities described herein may be embodied by a computer that performs and/or all of the functions and/or steps described.

Any recitation of “a,” “an,” or “the” is intended to mean “one or more” unless specifically indicated to the contrary.

The above description is illustrative and is not restrictive. Many variations of aspects of the disclosure will become apparent to those skilled in the art upon review of the disclosure.

What is claimed is:

1. A method comprising:
generating, by a voice response unit, an introduction to a menu, the menu comprising a plurality of menu options, the menu options including a first configured menu option in the plurality of menu options, wherein the first configured menu option provides a first action, and a second configured menu option in the plurality of menu options, wherein the second configured menu option provides a second action;
initiating, by the voice response unit, the first action if the first menu option is selected; and
initiating, by the voice response unit, the second action if the second menu option is selected.

2. The method of claim 1, wherein the first action is a first force transfer to a first call center and the second action is a second transfer to a second call center, wherein the first force transfer transfers a call to the first call service center based on one or more routing factors.

3. The method of claim 2, wherein the one or more routing factors include call center availability based on the date or time of the call.

4. The method of claim 2, wherein the one or more routing factors include wait time.

5. The method of claim 1, wherein the second configured menu option is subsequent to the first configured menu option in the plurality of menu options.

6. The method of claim 1 further comprising:
receiving one or more menu option codes, wherein the one or more menu option codes are associated with data about a caller;
generating a profile for the caller, wherein the profile comprises the data about the caller;
providing the profile to the first call service center if the first menu option is selected; and
providing the profile to the second call service center if the second option is selected.

7. The method of claim 1 further comprising:
storing in a database, a string of menu options wherein at least one value in the string of menu options corresponds to the first configured menu option or the second configured menu option;
receiving a string of selected values;
comparing the string of selected values to the string of menu options;
initiating the first force transfer to the first call service center if the first configured menu option corresponds to at least one of the values in the string of selected values; and
initiating the second force transfer to the second call service center if the second configured menu option corresponds to at least one of the values in the string of selected values.

8. The method of claim 7 wherein the string of selected values ends with the first configured menu option or second configured menu option, corresponding to the last selection made by a caller.

9. A voice response unit comprising:
a processor; and
a computer readable medium coupled to the processor, the computer readable medium comprising code, for executing a method comprising:
generating, by a processor, an introduction to a menu, the menu comprising a plurality of menu options, the menu options including a first configured menu option in the plurality of menu options, wherein the first configured menu option provides a first action, and a second configured menu option in the plurality of menu options, wherein the second configured menu option provides a second action;
initiating, by the processor, the first action if the first configured menu option is selected; and
initiating, by the processor, the second action if the second configured menu option is selected.

10. The voice response unit of claim 9, wherein the first action is a first force transfer to a first call center and the second action is a second force transfer to a second call center, wherein the first force transfer transfers a call to the first call service center based on one or more routing factors.

11. The voice response unit of claim 10, wherein the one or more routing factors include call center availability based on the date or time of the call.

12. The voice response unit of claim 10, wherein the one or more routing factors include wait time.

13. The voice response unit of claim 9, wherein the second configured menu option is subsequent to the first configured menu option in the plurality of menu options.

14. The voice response unit of claim 9 further comprising:
receiving one or more selected values, wherein the one or more selected values are associated with data about a caller;
generating a profile for the caller, wherein the profile comprises the data about the caller;
providing the profile to the first call service center if the first configured menu option is selected; and
providing the profile to the second call service center if the second configured option is selected.

15. The voice response unit of claim 9 further comprising:
storing in a database, a string of menu options wherein at least one value in the string of menu options corresponds to the first configured menu option or the second configured menu option;
receiving a string of selected values;
comparing the string of selected values to the string of menu options;
initiating the first force transfer to the first call service center if the first configured menu option corresponds to at least one of the values in the string of selected values; and
initiating the second force transfer to the second call service center if the second configured menu option corresponds to at least one of the values in the string of selected values.

16. The voice response unit of claim 15 wherein the string of selected values ends with the first configured menu option or second configured menu option, corresponding to the last selection made by a caller.

17. A method comprising:
generating a menu wherein the menu includes a plurality of configurable menu options;
storing, in a database, data associated with the plurality of configurable menu options;
allowing a user to configure one of the menu options to create a configured menu option; and receiving the configured menu option at the database.

18. The method of claim 17, wherein the configured menu option corresponds with a forced transfer.

19. The method of claim 18, wherein the forced transfer transfers a caller to a first call service center.

20. A voice response unit comprising:
a processor; and
a computer readable medium coupled to the processor, the computer readable medium comprising code, for executing a method comprising:
generating a menu wherein the menu includes a plurality of configurable menu options;
storing, in a database, data associated with the plurality of configurable menu options;
allowing a user to configure one of the menu options to create a configured menu option; and
receiving the configured menu option at the database.

21. The voice response unit of claim 20, wherein the configured menu option corresponds with a forced transfer.

22. The voice response unit of claim 21, wherein the forced transfer transfers a caller to a first call service center.
